(19) United States
(12) Patent Application Publication
(10) Pub. No.: US 2026/0352052 A1
(43) Pub. Date: Nov. 5, 2026

(54) STATOR

(71) Applicant: DENSO CORPORATION, Kariya-city (JP)

(72) Inventors: Ryo MITANI, Kariya-city (JP); Naoto NATSUME, Kariya-city (JP); Masayuki ECHIZEN, Kariya-city (JP)

(73) Assignee: DENSO CORPORATION, Kariya-city (JP)

(21) Appl. No.: 19/727,029

(22) Filed: Jul. 1, 2026

Related U.S. Application Data
(63) Continuation of application No. PCT/JP2025/000078, filed on Jan. 6, 2025.

(30) Foreign Application Priority Data
Mar. 5, 2024 (JP) 2024-032882

(51) Int. Cl. H02K 3/32; H02K 1/14; H02K 15/106

(52) U.S. Cl. CPC H02K 3/325; H02K 1/146; H02K 15/106

(57) ABSTRACT

A stator comprises: a stator core having teeth extending radially and a plurality of slots each of which is formed between a respective adjacent two of the teeth; insulators installed on the stator core; a plurality of wire-wound portions wound around the teeth through the insulators; and the insulating member having insulating portions that are inserted into selected ones of the slots and electrically insulate the adjacent wire-wound portions from each other, and a connecting portion that connects the insulating portions.

### CROSS REFERENCE TO RELATED DOCUMENT

The present application claims the benefit of priority of Japanese Patent Application No. 2024-032882 filed on Mar. 5, 2024, the disclosure of which is incorporated in its entirety by reference.

### TECHNICAL FIELD

This disclosure relates generally to a stator.

A stator is known which includes a stator core having a plurality of teeth extending radially and a plurality of slots each formed between a respective adjacent two of the teeth, insulators installed on the stator core, and a plurality of wire-wound portions wound around the teeth through the insulators. Further, among such stators, there is one having a configuration in which insulating sheets are inserted into the slots in order to electrically insulate adjacent wire-wound portions from each other (see, for example, Japanese Patent Application Laid-Open No. 2008-042959). According to this stator, insulation between the adjacent wire-wound portions can be ensured.

### SUMMARY OF THE INVENTION

As a result of detailed studies conducted by the inventor, the following problem has been found. Specifically, when a plurality of insulating sheets, which are separate components, are inserted one into each slot, the number of parts and assembly man-hours for the stator increase, which may increase production costs of the stator.

An object of the technology of the present disclosure is to provide a stator capable of reducing production costs thereof, as compared with a case where a plurality of insulating sheets having discrete configurations are inserted one into each slot.

According to the technology of the present disclosure, there is provided a stator which comprises: (a) a stator core that includes a plurality of teeth extending in a radial direction of the stator core and a plurality of slots formed between the teeth; (b) insulators installed in the stator core; (c) a plurality of wire-wound portions each of which is wound around a respective one of the teeth through a corresponding one of the insulators; and (d) an insulating member including a plurality of insulating portions inserted into selected ones of the slots and a connecting portion. Each of the insulating portions electrically insulates an adjacent two of the wire-wound portions from each other. The connecting portion connects the insulating portions together.

According to the technology of the present disclosure, there is provided a stator capable of reducing production costs as compared with a case where a plurality of insulating sheets, which are separate components, are inserted one into each slot.

### BRIEF DESCRIPTION OF THE DRAWINGS

FIG. 1 is a plan view of a stator according to a reference example.

FIG. 2 is a plan view of a stator according to the first embodiment.

FIG. 3 is a developed view showing a stator according to the first embodiment developed into a linear shape.

FIG. 4 is an enlarged view of a principal part of FIG. 3.

FIG. 5 is a perspective view showing a state in which an insulating member is attached to a stator core member according to the first embodiment.

FIG. 6 is a perspective view of an insulating member according to the first embodiment.

FIG. 7 is an explanatory view illustrating attachment of an insulating member to a stator core member according to the first embodiment.

FIG. 8 is a plan view showing a state in which an insulating member is attached to a stator core member according to the first embodiment.

FIG. 9 is an enlarged perspective view of a principal part of a stator according to the first embodiment.

FIG. 10 is a developed view showing a stator according to the second embodiment developed into a linear shape and is an enlarged view of a principal part.

FIG. 11 is a perspective view of an insulating member according to the second embodiment.

FIG. 12 is an explanatory view illustrating attachment of an insulating member to a stator core member according to the second embodiment.

FIG. 13 is a developed view showing a stator according to the third embodiment developed into a linear shape.

FIG. 14 is an enlarged view of a principal part of FIG. 13.

FIG. 15 is a perspective view showing a state in which an insulating member is attached to a stator core member according to the third embodiment.

FIG. 16 is a perspective view of an insulating member according to the third embodiment.

FIG. 17 is an explanatory view illustrating attachment of an insulating member to a stator core member according to the third embodiment.

FIG. 18 is a plan view of a stator according to the fourth embodiment.

FIG. 19 is a developed view showing a stator according to the fourth embodiment developed into a linear shape.

FIG. 20 is a perspective view showing a state in which an insulating member is attached to a stator core member according to the fourth embodiment.

FIG. 21 is a perspective view of an insulating member according to the fourth embodiment

FIG. 22 is a plan view showing a state in which an insulating member is attached to a stator core member according to the fourth embodiment.

FIG. 23 is a plan view of a stator according to a first modification of the fourth embodiment.

FIG. 24 is a perspective view showing a state in which an insulating member is attached to stator core members according to the first modification of the fourth embodiment.

FIG. 25 is a perspective view of an insulating member according to the first modification of the fourth embodiment.

FIG. 26 is a plan view showing a state in which an insulating member is attached to stator core members according to the first modification of the fourth embodiment.

FIG. 27 is a perspective view showing a state in which an insulating member is attached to stator core members according to a second modification of the fourth embodiment.

FIG. 28 is a perspective view of an insulating member according to the second modification of the fourth embodiment.

FIG. 29 is a perspective view showing a state in which an insulating member is attached to stator core members according to a third modification of the fourth embodiment.

FIG. 30 is a perspective view of an insulating member according to the third modification of the fourth embodiment.

FIG. 31 is a plan view of a stator according to the fifth embodiment.

FIG. 32 is a developed view showing a stator according to the fifth embodiment developed linearly.

FIG. 33 is a perspective view of an insulating member according to the fifth embodiment.

FIG. 34 is a plan view of an insulating member according to the fifth embodiment.

FIG. 35 is a perspective view of an insulating member according to the sixth embodiment.

FIG. 36 is a plan view of an insulating member according to the sixth embodiment.

FIG. 37 is a plan view of a stator according to the seventh embodiment.

FIG. 38 is a perspective view of an insulating member according to the seventh embodiment.

FIG. 39 is a plan view of an insulating member according to the seventh embodiment.

FIG. 40 is a plan view of a stator according to the eighth embodiment.

FIG. 41 is a developed view showing a stator according to the eighth embodiment developed linearly.

FIG. 42 is a perspective view of an insulating member according to the eighth embodiment.

FIG. 43 is a plan view of an insulating member according to the eighth embodiment.

FIG. 44 is a plan view of a stator according to the first modified example of the eighth embodiment.

FIG. 45 is a perspective view of an insulating member according to the first modified example of the eighth embodiment.

FIG. 46 is a plan view of an insulating member according to the first modified example of the eighth embodiment.

FIG. 47 is a perspective view of an insulating member according to the second modified example of the eighth embodiment.

FIG. 48 is a plan view of an insulating member according to the second modified example of the eighth embodiment.

FIG. 49 is a perspective view of an insulating member according to the third modified example of the eighth embodiment.

FIG. 50 is a plan view of an insulating member according to the third modified example of the eighth embodiment.

FIG. 51 is a developed view showing a stator according to the ninth embodiment developed linearly.

FIG. 52 is a perspective view of an insulating member according to the ninth embodiment.

FIG. 53 is a plan view of an insulating member according to the ninth embodiment.

FIG. 54 is a developed view showing a stator according to the tenth embodiment developed linearly.

FIG. 55 is a perspective view of an insulating member according to the tenth embodiment.

FIG. 56 is a plan view of a stator according to the tenth embodiment.

FIG. 57 is a plan view of a stator according to the eleventh embodiment.

FIG. 58 is a perspective view of an insulating member according to the eleventh embodiment.

FIG. 59 is a plan view of an insulating member according to the eleventh embodiment.

### MODES FOR CARRYING OUT THE INVENTION

### Reference Examples

First, a stator according to a reference example, which is a premise of a stator according to first to eleventh embodiments of the technology of the present disclosure to be described later, will be described.

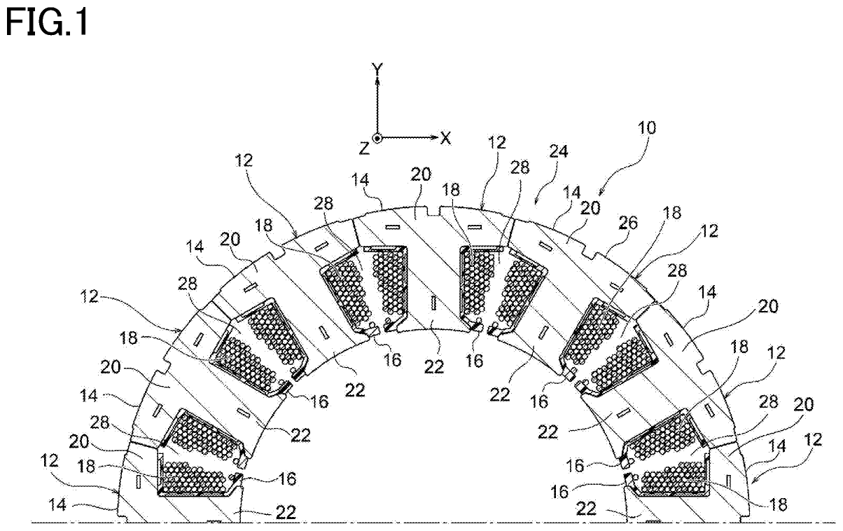

As shown in FIG. 1, the stator 10 includes a plurality of stator core members 12. The stator 10 is configured by the stator core members 12 being combined in an annular shape. FIG. 1 shows a configuration of half of the stator 10. The stator 10 is applied to a brushless motor. The brushless motor may be used for any application. Examples of the brushless motor include a fan motor, a pump-driving motor, a compressor motor, and the like.

Throughout the drawings, the X-direction indicates a tangential direction of the stator 10, the Y-direction indicates a radial direction of the stator 10, and the Z-direction indicates an axial direction of the stator 10. Further, in the following description, a circumferential direction of the stator 10 refers to a direction around the center axis of the stator 10. A tangential direction, a radial direction, an axial direction, and a circumferential direction of the stator core 24, which will be described later, are the same as the tangential direction, the radial direction, the axial direction, and the circumferential direction of the stator 10, respectively.

Each of the stator core members 12 includes the core member 14, the insulator 16, and the wire-wound portion (i.e., a conductor winding) 18. The core member 14 is formed in a T-shape in a plan view, and has the core back 20 and the tooth 22. The core back 20 extends in the circumferential direction of the stator core 24. The tooth 22 extends from a central portion of the core back 20 inward in the radial direction of the stator core 24. A distal end portion of the tooth 22 is the free end, and a proximal end portion of the tooth 22 is connected to the core back 20.

The stator core 24 is configured by arranging the core members 14 in an annular shape. After the stator core 24 is configured, the core backs 20 form the annular portion 26 (see FIG. 1) that is an outer peripheral portion of the stator core 24. The teeth 22 extend radially around the central portion of the stator core 24. An interval between a respective adjacent two of the teeth 22 is formed as the slot 28.

In each of the stator core members 12, the insulator 16 is installed on the core member 14. Specifically, the insulator 16 is installed on the tooth 22 so as to surround the tooth 22 around the Y-direction. The insulator 16 is made of resin. Examples of the resin forming the insulator 16 include the polyimide, the polyamide, the polyphenylene sulfide (PPS), the polybutylene terephthalate (PBT), and the like. The resin forming the insulator 16 may be any resin. For the sake of simplicity, the following discussion refers to only one of the stator core members 12 unless otherwise specified.

The wire-wound portion 18 is formed by wire wound around the tooth 22 through the insulator 16. The wire-wound portion 18 is made of a winding wound around the tooth 22 in the radial direction of the stator core 24.

By the way, in order to electrically insulate the adjacent wire-wound portions 18 from each other when a high voltage is applied to the wire-wound portions 18, the stator 10 having the above configuration may be designed such that insulating sheets are installed in the slots 28. The insertion of a plurality of discrete insulating sheets, one into each of the slots 28, usually leads to an increase in the number of parts of the stator 10, resulting in an increase in production costs. The stator 10 according to the first to tenth embodiments described below aims to reduce costs as compared with a case in which a plurality of discrete insulating sheets are inserted individually into the slots 28.

Note that in the following description, the arrow Z1-side indicates one side in the axial direction of the stator core 24, and the arrow Z2-side indicates the other side in the axial direction of the stator core 24.

### First Embodiment

The stator 10 according to the first embodiment will be described below.

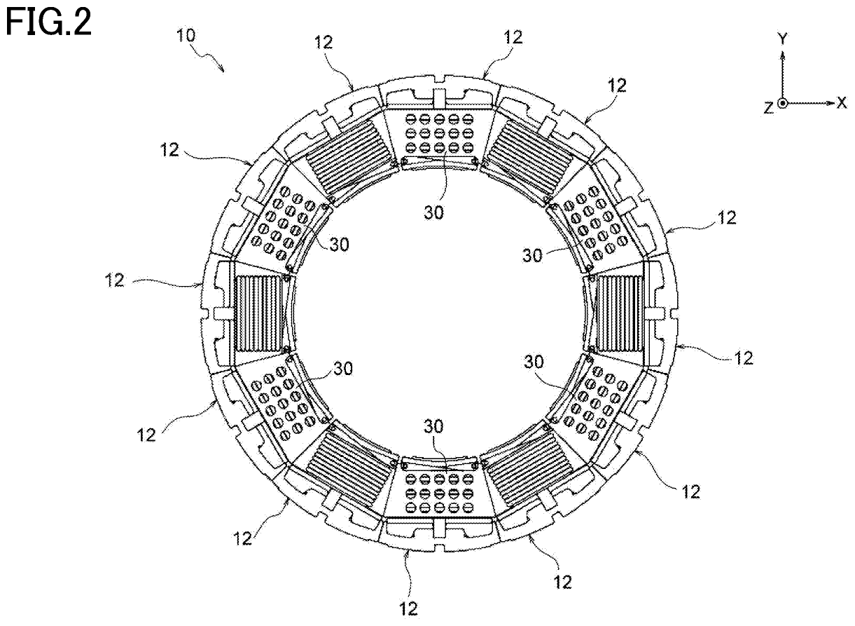

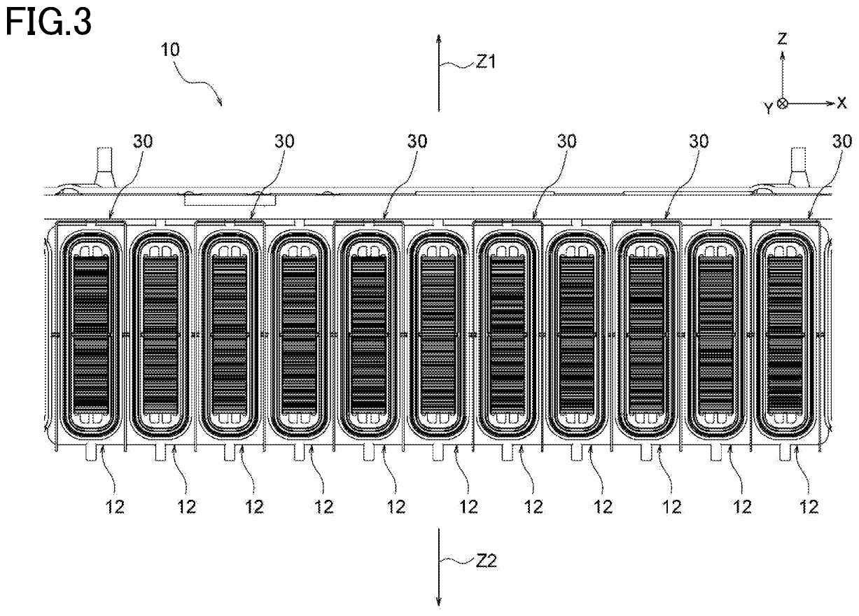

As shown in FIGS. 2 and 3, the stator 10 includes a plurality of insulating members 30. The insulating members 30 are attached to every other one of the plurality of stator core members 12. Each insulating member 30 is installed on one stator core member 12. Each insulating member 30 has the same configuration, and is attached to the stator core member 12 in the same orientation.

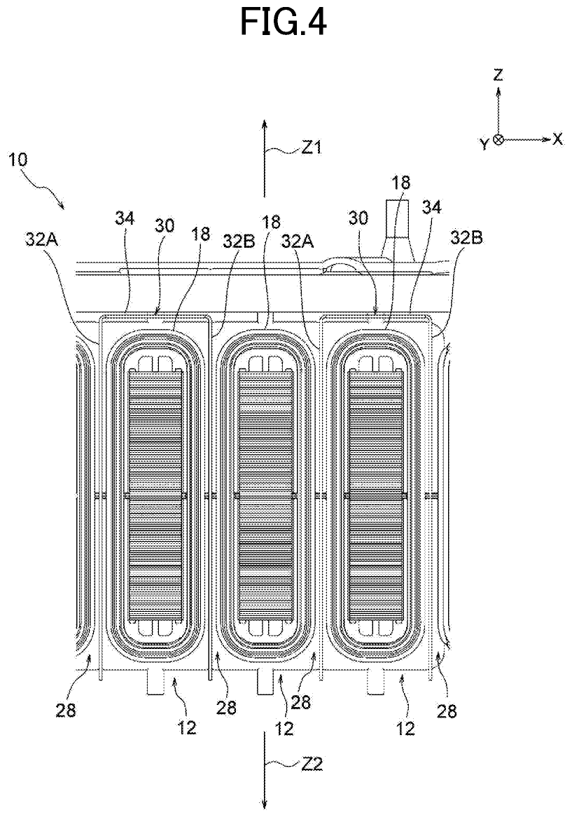

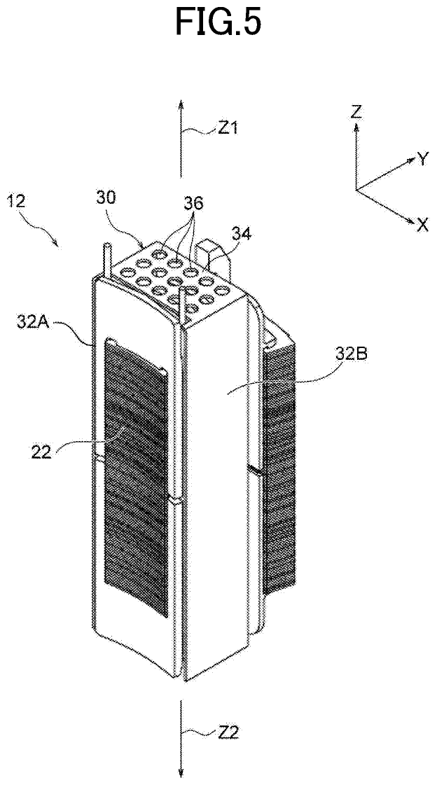

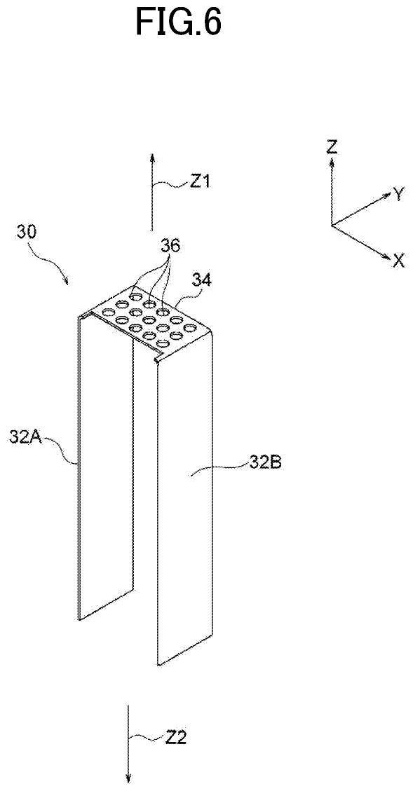

As shown in FIGS. 4 to 6, each of the insulating members 30 has the first insulating portion 32A, the second insulating portion 32B, and the connecting portion 34. The first insulating portion 32A and the second insulating portion 32B are an example of a “plurality of insulating portions” according to the technology of the present disclosure. Each insulating member 30 is formed of, for example, a sheet-like member made of resin having insulating property.

In each of the insulating members 30, the first insulating portion 32A is inserted into a corresponding one of the slots 28, and the second insulating portion 32B is inserted into one of the slots 28 adjacent to the slot 28 into which the first insulating portion 32A is inserted. In the first embodiment, either the first insulating portions 32A or the second insulating portions 32B of the insulating members 30 are inserted into all of the slots 28. The slot 28 into which each of the first insulating portions 32A is inserted is an example of a “selected slot” and a “first selected slot” according to the technology of the present disclosure, and the slot 28 into which each of the second insulating portions 32B is inserted is an example of a “selected slot” and a “second selected slot” according to the technology of the present disclosure.

The first insulating portion 32A extends both in the Y-direction and in the Z-direction. In a state of being inserted into the slot 28, the first insulating portion 32A is arranged between the adjacent wire-wound portions 18 and insulates between the adjacent wire-wound portions 18. Similarly, the second insulating portion 32B extends both in the Y-direction and in the Z-direction. In a state of being inserted into the slot 28, the second insulating portion 32B is arranged between the adjacent wire-wound portions 18 and insulates between the adjacent wire-wound portions 18. The connecting portion 34 extends both in the X-direction and the Y-direction. The connecting portion 34 is arranged on the arrow Z1-side of the wire-wound portion 18, and connects ends (which will also be referred to below as first ends) of the first insulating portion 32A and the second insulating portion 32B to each other on the arrow Z1-side.

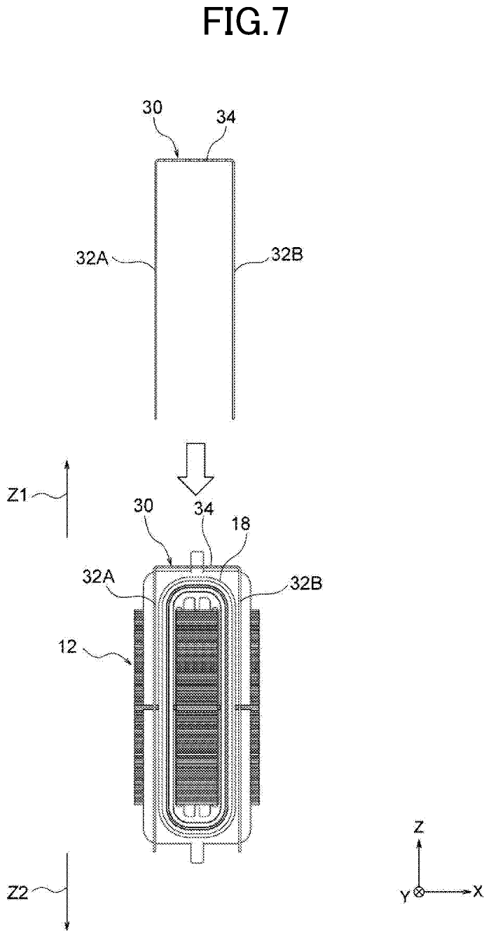

As shown in FIG. 7, the insulating member 30 is attached to the stator core member 12 from the arrow Z1-side. More specifically, the insulating member 30 is attached to the wire-wound portion 18 of the stator core member 12. In a state where the insulating member 30 is installed on the wire-wound portion 18, the first insulating portion 32A and the second insulating portion 32B are arranged along an axially extending portion of the wire-wound portion 18 which extends in the Z-direction. The connecting portion 34 is arranged along a tangentially extending portion of the wire-wound portion 18 which extends in the X-direction. Each of the insulating members 30 may be attached to the stator core members 12 before the stator core members 12 are combined in an annular shape, or may be attached to the stator core members 12 after the core members 12 are combined in the annular shape.

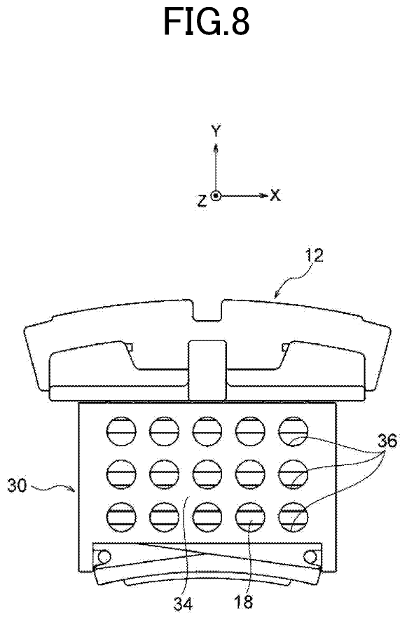

As shown in FIG. 8, the connecting portion 34 has a plurality of through-holes 36 extending in the Z-direction. The number of the through-holes 36 may be any number. Further, the connecting portion 34 may have one through-hole 36.

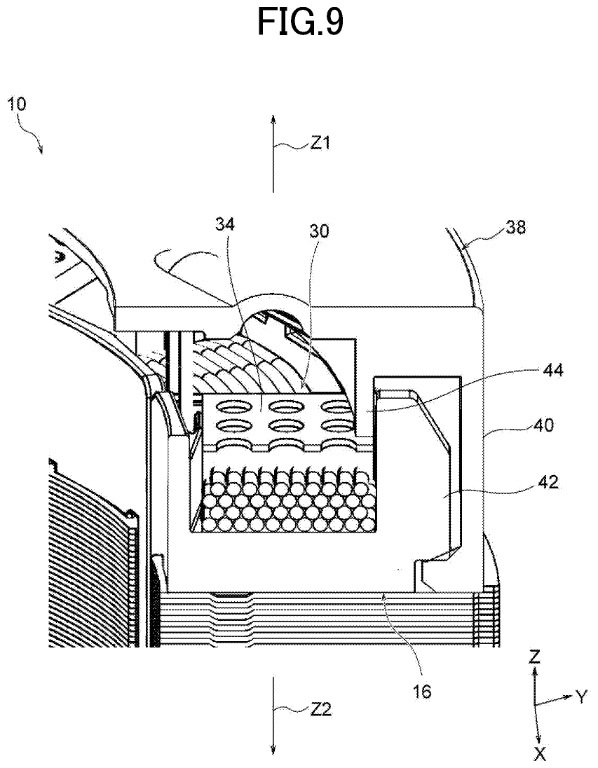

As shown in FIG. 9, the stator 10 has the insulator cover 38. The insulator cover 38 is arranged on the arrow Z1-side of the insulating members 30. The insulator cover 38 has the fitted portion 40, while the insulators 16 have the fitting portions 42. The insulator cover 38 is fixed to the insulators 16 by the fitted portion 40 engaging the fitting portions 42 of the insulators 16. The insulator cover 38 has the pressing portion 44. The pressing portion 44 extends in the Z-direction toward the insulating members 30 (i.e., the arrow Z2-side) and presses the insulating members 30. More specifically, the pressing portion 44 presses the connecting portions 34.

As described in detail above, the stator 10 according to the first embodiment includes the insulating members 30. Each of the insulating members 30 includes the first insulating portion 32A inserted into one of the slots 28, the second insulating portion 32B inserted into one of the slots 28 adjacent to the slot 28 in which the first insulating portion 32A is installed, and the connecting portion 34 connecting the first insulating portion 32A and the second insulating portion 32B to each other. Therefore, as compared with a case in which a plurality of insulating sheets, which are separate components, are disposed one in each of the slots 28, the number of parts of the stator 10 and assembly man-hours may be reduced, and thus production costs may be decreased.

Further, each of the connecting portions 34 connects ends of a corresponding one of the first insulating portions 32A and a corresponding one of the second insulating portions 32B to each other on the arrow Z1-side. This enables the insulating members 30 to be attached to the stator core members 12 from the arrow Z1-side, thereby improving the workability during assembly of the stator 10.

Further, in each of the insulating members 30, the first insulating portion 32A is inserted into one of the slots 28, while the second insulating portion 32B is inserted into one of the slots 28 which is located adjacent to the slot 28 into which the first insulating portion 32A is disposed. This layout enables the insulating members 30 to be attached to the stator core members 12 every other one.

Further, each of the connecting portions 34 is arranged on the arrow Z1-side of a corresponding one of the wire-wound portions 18, and has a plurality of through-holes 36 opening in the Z-direction. Therefore, cooling air flowing in the Z-direction and supplied to the wire-wound portions 18 passes through the through-holes 36, thereby ensuring cooling performance for the wire-wound portions 18.

### Second Embodiment

The stator 10 according to the second embodiment will be described below.

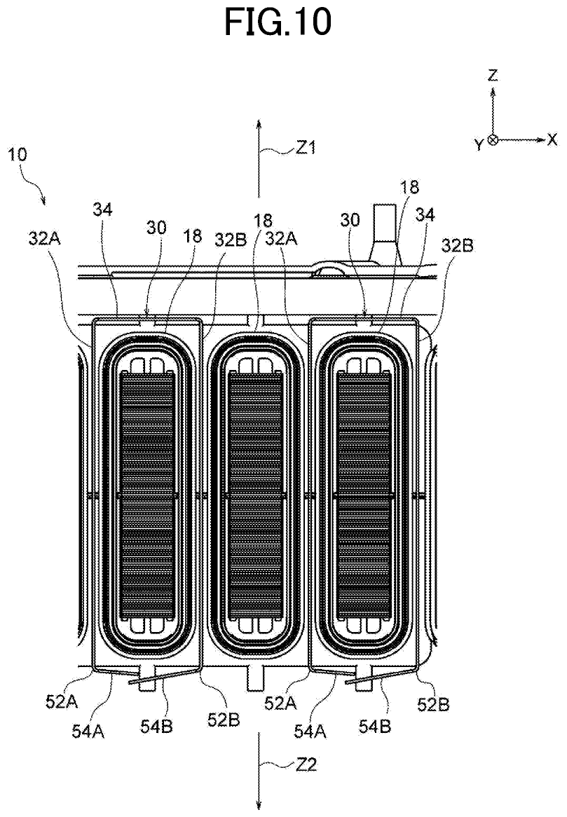

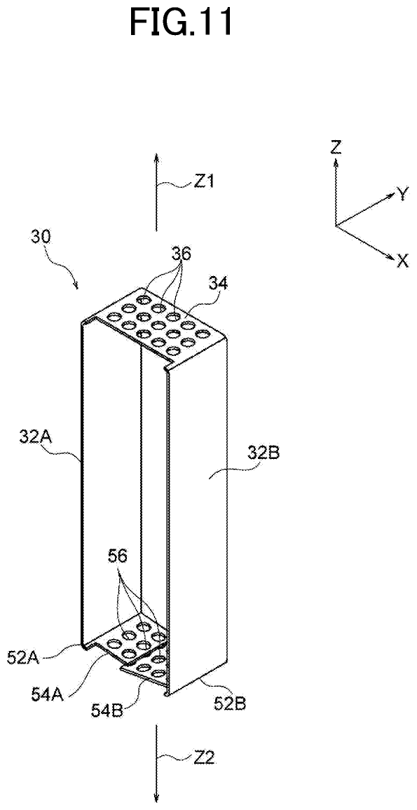

The second embodiment is different from the first embodiment in the configuration of each of the insulating members 30. Specifically, as shown in FIGS. 10 and 11, the first insulating portion 32A has the first tip portion 52A located on a side opposite to the connecting portion 34. The first tip portion 52A includes the first extending portion 54A. The first extending portion 54A is arranged on the arrow Z2-side of the wire-wound portion 18 and extends toward the second insulating portion 32B.

Similarly, the second insulating portion 32B has the second tip portion 52B located on a side opposite to the connecting portion 34. The second tip portion 52B includes the second extending portion 54B. The second extending portion 54B is arranged on the arrow Z2-side of the wire-wound portion 18 and extends toward the first insulating portion 32A.

The first extending portion 54A and the second extending portion 54B have a plurality of through-holes 56 opening in the Z-direction. The number of the through-holes 56 may be any number. Further, the first extending portion 54A and the second extending portion 54B may respectively have one through-hole 56.

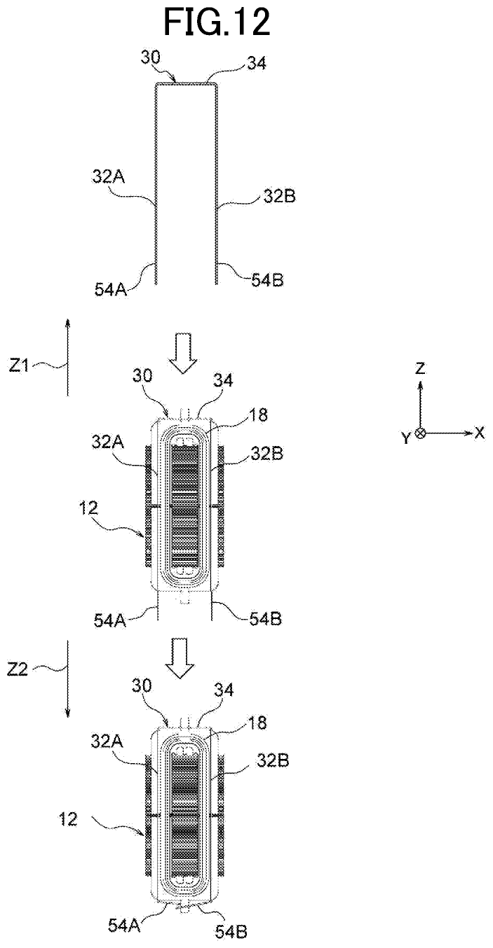

As shown in FIG. 12, each of the insulating members 30 is assembled to a corresponding one of the stator core members 12 from the arrow Z1-side with the first extending portion 54A and the second extending portion 54B extending in the Z-direction. Then, the first extending portion 54A is bent toward the second insulating portion 32B, while the second extending portion 54B is bent toward the first insulating portion 32A, whereby the insulating member 30 is attached to the stator core member 12. The insulating members 30 may be attached to the stator core members 12 before the stator core members 12 are combined in an annular shape, or may be attached to the stator core members 12 after the stator core members 12 are combined in the annular shape.

In the second embodiment, as described above, the first extending portion 54A extending toward the second insulating portion 32B is formed at the first tip portion 52A of the first insulating portion 32A, while the second extending portion 54B extending toward the first insulating portion 32A is formed at the second tip portion 52B of the second insulating portion 32B. The first extending portion 54A and the second extending portion 54B are arranged on the arrow Z2-side of the wire-wound portion 18. This layout minimizes a risk that the insulating member 30 may be detached toward the arrow Z1-side from the stator core member 12.

Further, the first extending portion 54A and the second extending portion 54B of each of the insulating members 30 have the plurality of through-holes 56 opening in the Z-direction. This enables cooling air flowing in the Z-direction and supplied to the wire-wound portion 18 to pass through the through-holes 56, thereby ensuring cooling performance for the wire-wound portion 18.

### Third Embodiment

The stator 10 according to the third embodiment will be described below.

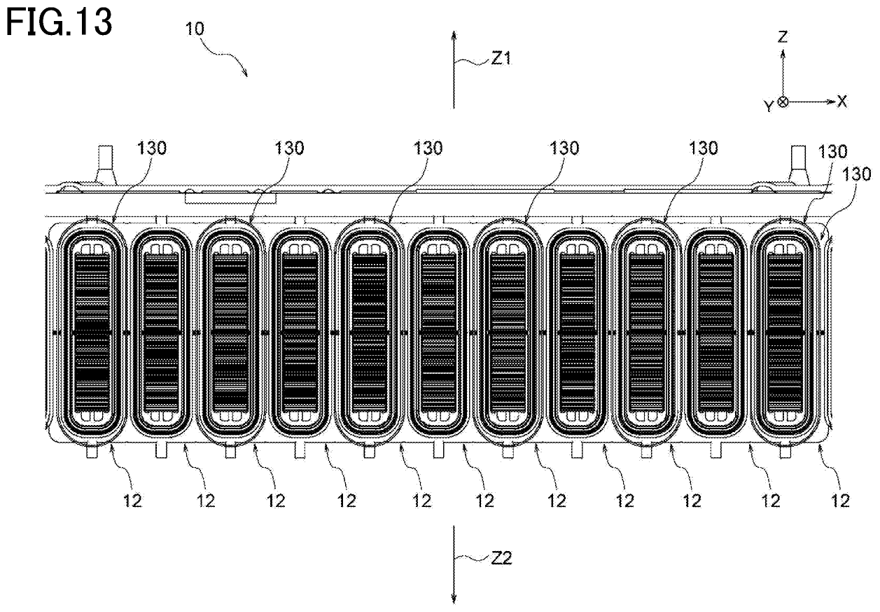

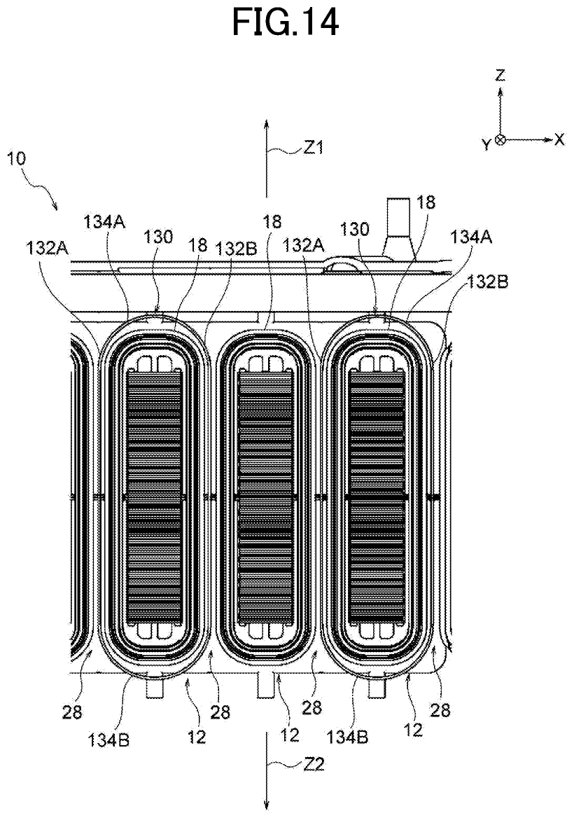

As shown in FIGS. 13 and 14, the third embodiment is designed to use a plurality of insulating members 130 instead of the plurality of insulating members 30 (see FIGS. 2 and 3) in the first embodiment. The insulating members 130 are attached to every other one of the plurality of stator core members 12. Each of the insulating members 130 is attached to a respective one of the stator core members 12. The insulating members 130 have the same configuration and are attached to the stator core members 12 in the same orientation.

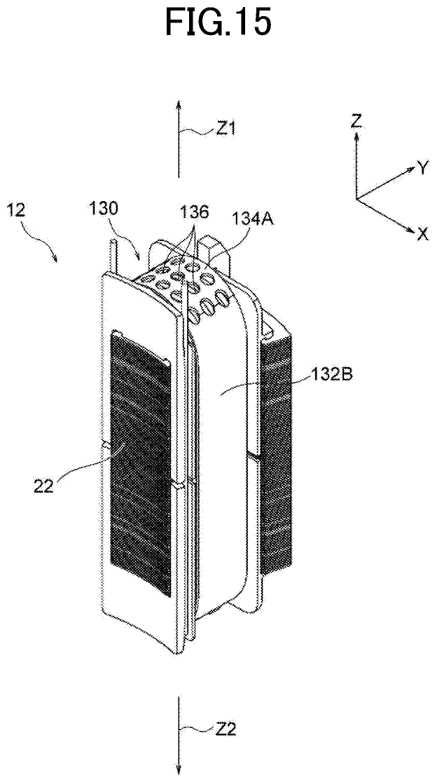

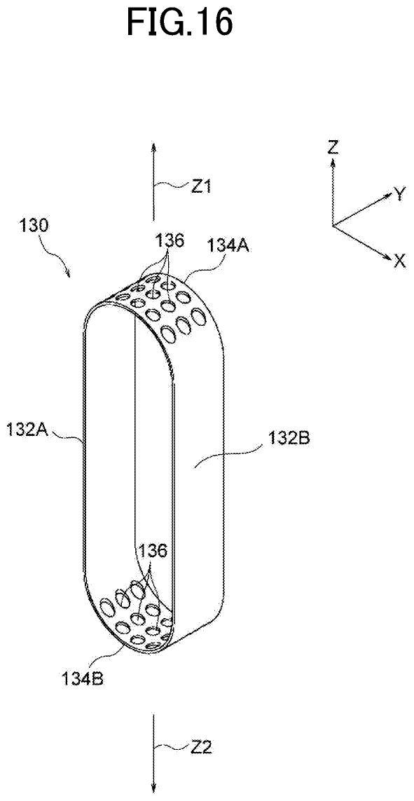

Each of the insulating members 130 has the first insulating portion 132A, the second insulating portion 132B, the first connecting portion 134A, and the second connecting portion 134B (see also FIGS. 15 and 16). The first insulating portion 132A and the second insulating portion 132B are an example of a “plurality of insulating portions” according to the technology of the present disclosure. The first connecting portion 134A and the second connecting portion 134B are an example of a “connecting portion” in the present disclosure. Each of the insulating members 130 is formed of a heat-shrinkable tube having heat shrinkability.

In each of the insulating members 130, the first insulating portion 132A is inserted into one of the slots 28, while the second insulating portion 132B is inserted into one of the slots 28 adjacent to the slot 28 into which the first insulating portion 132A is inserted. In the second embodiment, like the first embodiment, each of the slots 28 receives a corresponding one of the first insulating portions 132A and the second insulating portions 132B. The slot 28 into which the first insulating portion 132A is inserted is an example of a “selected slot” and a “first selected slot” in the present disclosure, and the slot 28 into which the second insulating portion 132B is inserted is an example of a “selected slot” and a “second selected slot” in the present disclosure.

The first insulating portion 132A extends both in the Y-direction and in the Z-direction. In a state of being inserted into one of the slots 28, the first insulating portion 132A is arranged between the adjacent wire-wound portions 18 and insulates between the adjacent wire-wound portions 18. Similarly, the second insulating portion 132B extends both in the Y-direction and in the Z-direction. In a state of being inserted into one of the slots 28, the second insulating portion 132B is arranged between the adjacent wire-wound portions 18 and insulates between the adjacent wire-wound portions 18.

The first connecting portion 134A extends both in the X-direction and in the Y-direction. The first connecting portion 134A is arranged on the arrow Z1-side of the wire-wound portion 18 and connects first ends of the first insulating portion 132A and the second insulating portion 132B to each other on the arrow Z1-side. Similarly, the second connecting portion 134B extends both in the X-direction and in the Y-direction. The second connecting portion 134B is arranged on the arrow Z2-side of the wire-wound portion 18 and connects second ends of the first insulating portion 132A and the second insulating portion 132B to each other on the arrow Z2-side.

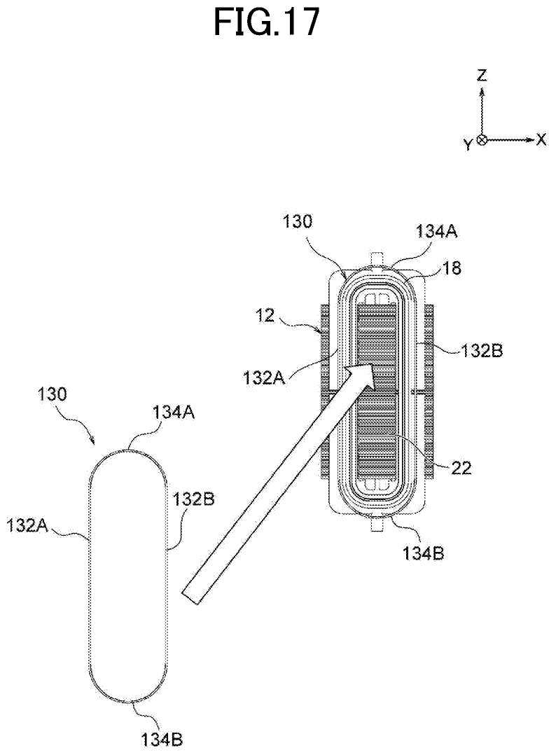

As shown in FIG. 17, the insulating member 130 is assembled to the stator core member 12 from a tip side of the tooth 22. More specifically, the insulating member 130 is fitted on an outer periphery of the wire-wound portion 18 of the stator core member 12. When heat is applied to the insulating member 130 by a heater, it causes the insulating member 130 to shrink, so that the insulating member 130 is firmly secured to the outer periphery of the wire-wound portion 18.

In a state where the insulating member 130 is attached to the outer periphery of the wire-wound portion 18, the first insulating portion 132A and the second insulating portion 132B are arranged along axially extending portions of the wire-wound portion 18 in the Z-direction, while the first connecting portion 134A and the second connecting portion 134B are arranged along tangentially extending portions of the wire-wound portion 18 in the X-direction. The insulating members 130 may be attached to the stator core members 12 before the stator core members 12 are combined in an annular shape, or may be attached to the stator core members 12 after the stator core members 12 are combined in the annular shape.

Each of the first connecting portion 134A and the second connecting portion 134B has a plurality of through-holes 136 (see FIGS. 15 and 16) opening in the Z-direction. The number of the plurality of through-holes 136 may be any number. Further, the first connecting portion 134A and the second connecting portion 134B may respectively have one through-hole 136.

As described in detail above, the stator 10 according to the third embodiment includes the insulating members 130. Each of the insulating members 130 includes the first insulating portion 132A inserted into one of the slots 28 and the second insulating portion 132B inserted into one of the slots 28 adjacent to the slot 28 into which the first insulating portion 132A is inserted. Each of the insulating members 130 also includes the first connecting portion 134A connecting the first ends of the first insulating portion 132A and the second insulating portion 132B to each other on the arrow Z1-side, and the second connecting portion 134B connecting the second ends of the first insulating portion 132A and the second insulating portion 132B to each other on the arrow Z2-side. Therefore, as compared with a case where a plurality of insulating sheets, which are separate components, are inserted one by one for each slot 28, the number of parts and assembly man-hours can be reduced, and thus costs can be reduced.

Further, each of the insulating members 130 is formed of a heat-shrinkable tube having heat shrinkability. Therefore, for example, by assembling the insulating member 130 to the outer periphery of the wire-wound portion 18 from the tip side of the tooth 22 and applying heat to the insulating member 130 by a heater to shrink the insulating member 130, the insulating member 130 is firmly attached to the outer periphery of the wire-wound portion 18, and thus workability during assembly can be improved.

Further, the first connecting portion 134A is arranged on the arrow Z1-side of the wire-wound portion 18 and has a plurality of through-holes 136 opening in the Z-direction. Similarly, the second connecting portion 134B is arranged on the arrow Z2-side of the wire-wound portion 18 and has a plurality of through-holes 136 opening in the Z-direction. This arrangement of the through-holes 136 causes cooling air flowing in the Z-direction and supplied to the wire-wound portion 18 to pass through the through-holes 136, thereby maintaining cooling performance for the wire-wound portion 18.

### Fourth Embodiment

The stator 10 according to the fourth embodiment will be described below.

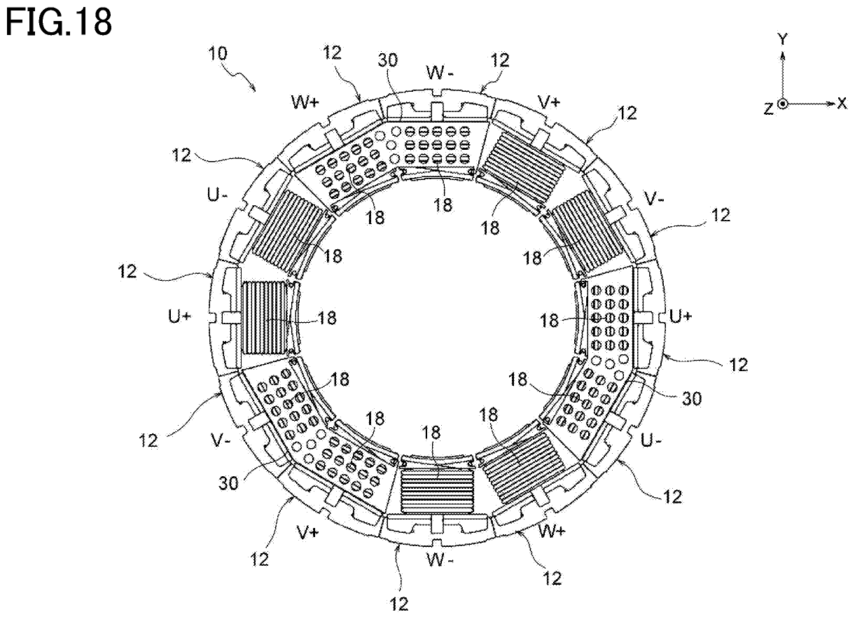

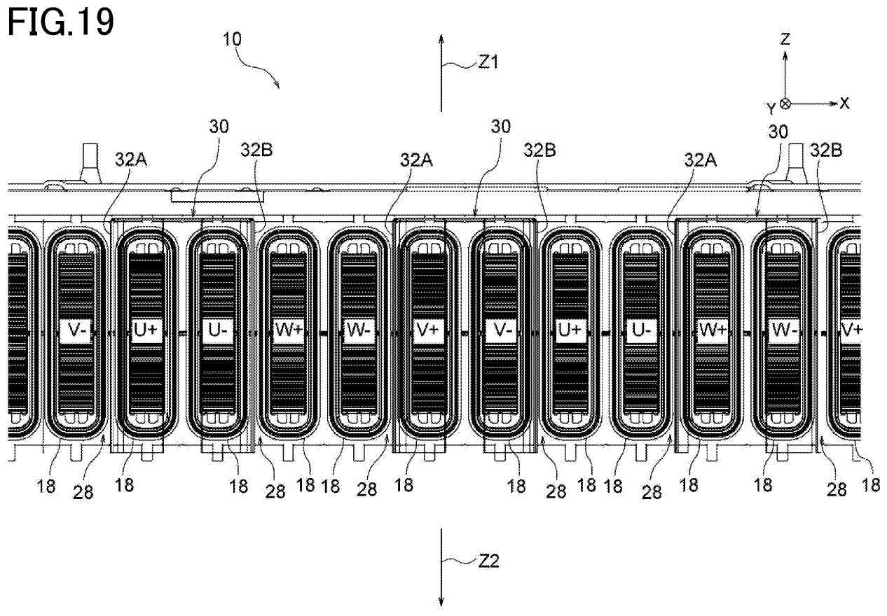

As shown in FIGS. 18 and 19, the stator 10 according to the fourth embodiment is configured to have 10 magnetic poles and 12 slots 28. The plurality of wire-wound portions 18 include U-phase wire-wound portions 18, V-phase wire-wound portions 18, and W-phase wire-wound portions 18. The U-phase wire-wound portions 18 include U+-phase wire-wound portions 18 and U-phase wire-wound portions 18. The V-phase wire-wound portions 18 include V+-phase wire-wound portions 18 and V-phase wire-wound portions 18. The W-phase wire-wound portions 18 include W+-phase wire-wound portions 18 and W-phase wire-wound portions 18.

The U+-phase wire-wound portions 18, the V+-phase wire-wound portions 18, and the W+-phase wire-wound portions 18 are made of wires wound in the forward direction. The U-phase wire-wound portions 18, the V—phase wire-wound portions 18, and the W-phase wire-wound portions 18 are made of wires wound in the reverse direction.

The plurality of wire-wound portions 18 are arranged in the clockwise direction in the order of the U+-phase wire-wound portion 18, the U-phase wire-wound portion 18, the W+-phase wire-wound portion 18, the W-phase wire-wound portion 18, the V+-phase wire-wound portion 18, the V-phase wire-wound portion 18, the U+-phase wire-wound portion 18, the U-phase wire-wound portion 18, the W+-phase wire-wound portion 18, the W-phase wire-wound portion 18, the V+-phase wire-wound portion 18, and the V-phase wire-wound portion 18.

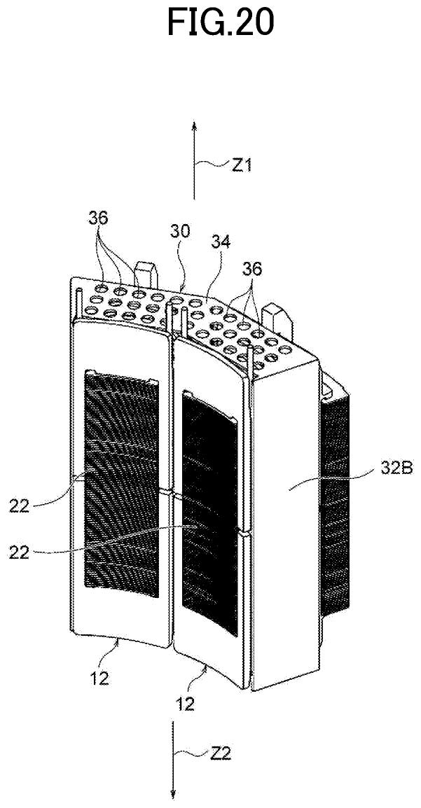

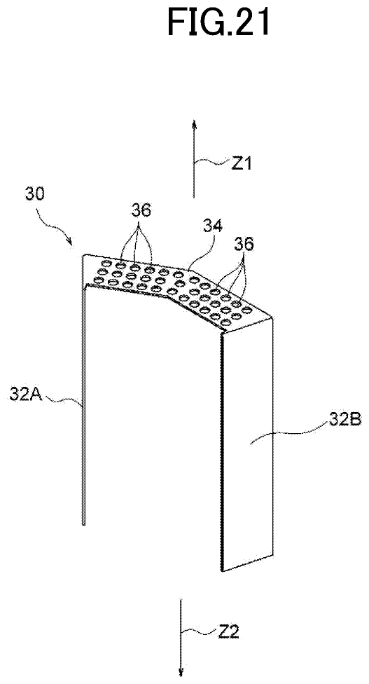

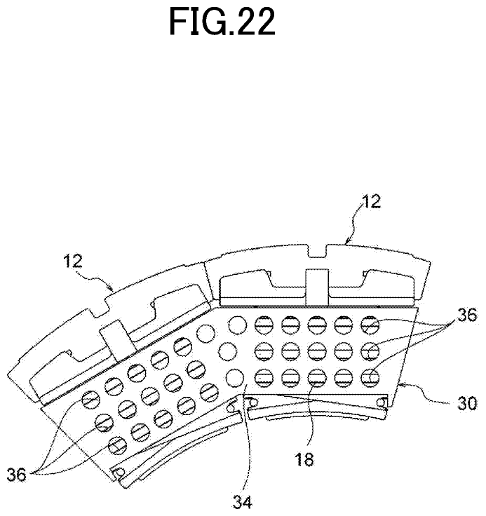

The fourth embodiment is different from the first embodiment only in the configuration of the plurality of insulating members 30. Specifically, the insulating members 30 are attached to every third one of the plurality of stator core members 12. Each of the insulating members 30 is attached to a respective two of the stator core members 12 (see also FIGS. 20 to 22). In each of the insulating members 30, the first insulating portion 32A is inserted into one of the slots 28, while the second insulating portion 32B is inserted into one of the slots 28 which is located two slots away from the slot 28 into which the first insulating portion 32A is inserted. The slot 28 into which the first insulating portion 32A is inserted is an example of a “selected slot” and a “first selected slot” in the present disclosure, and the slot 28 into which the second insulating portion 32B is inserted is an example of a “selected slot” and a “second selected slot” in the present disclosure.

More specifically, the insulating members 30 include U-phase insulating members 30, each of which is attached across one of the U+-phase wire-wound portions 18 and an adjacent one of the U-phase wire-wound portions 18, V-phase insulating members 30, each of which is attached across one of the V+-phase wire-wound portions 18 and an adjacent one of the V-phase wire-wound portions 18, and W-phase insulating members 30, each of which is attached across one of the W+-phase wire-wound portions 18 and an adjacent one of the W-phase wire-wound portions 18.

In each of the U-phase insulating members 30, the first insulating portion 32A is arranged between the U+-phase wire-wound portion 18 and the V-phase wire-wound portion 18, and the second insulating portion 32B is arranged between the U-phase wire-wound portion 18 and the W+-phase wire-wound portion 18.

In each of the V-phase insulating members 30, the first insulating portion 32A is arranged between the V+-phase wire-wound portion 18 and the W-phase wire-wound portion 18, and the second insulating portion 32B is arranged between the V-phase wire-wound portion 18 and the U+-phase wire-wound portion 18.

In each of the W-phase insulating members 30, the first insulating portion 32A is arranged between the W+-phase wire-wound portion 18 and the U-phase wire-wound portion 18, and the second insulating portion 32B is arranged between the W-phase wire-wound portion 18 and the V+-phase wire-wound portion 18.

In the fourth embodiment, neither each of the first insulating portions 32A nor each of the second insulating portions 32B is arranged between the wire-wound portions 18 of the same phase. However, since a potential difference between the wire-wound portions 18 of the same phase is lower than a potential difference between the wire-wound portions 18 of different phases, insulation between the wire-wound portions 18 of the same phase is unnecessary.

Each of the connecting portions 34, like in the first embodiment, has formed therein a plurality of through-holes 36 opening in the Z-direction.

The fourth embodiment is, as described above, designed not to establish insulation between the wire-wound portions 18 of the same phase, thereby reducing production costs as compared with a case where the wire-wound portions 18 of the same phase are electrically insulated.

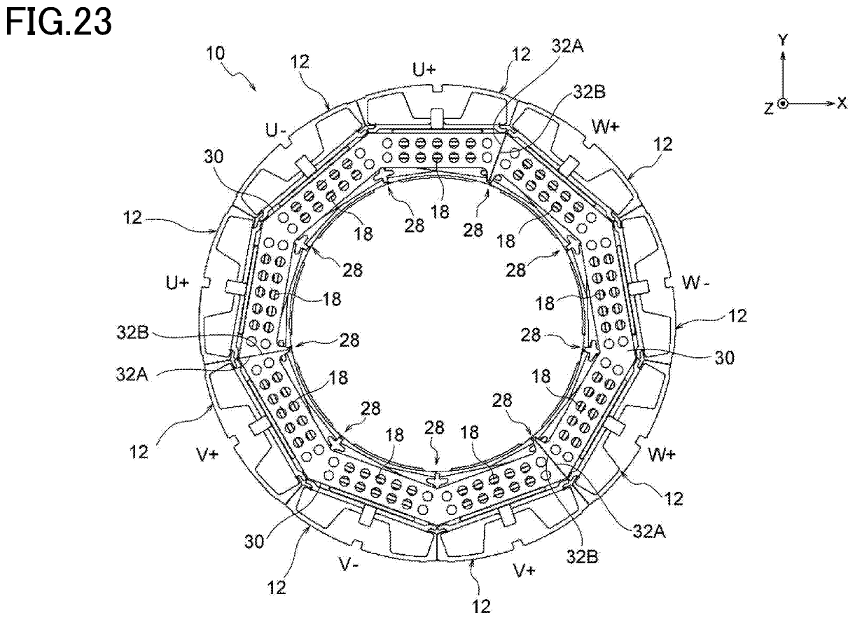

The stator 10 is, as described above, configured to have the 10 poles and the 12 slots 28. However, as shown in FIG. 23, the stator 10 may have 8 poles and 9 slots 28. Hereinafter, a modified example in a case where the stator 10 has 8 poles and 9 slots 28 will be described below.

The U-phase wire-wound portions 18 include the U+-phase wire-wound portion 18, the U-phase wire-wound portion 18, and the U+-phase wire-wound portion 18. The V-phase wire-wound portions 18 include the V+-phase wire-wound portion 18, the V-phase wire-wound portion 18, and the V+-phase wire-wound portion 18. The W-phase wire-wound portions 18 include the W+-phase wire-wound portion 18, the W—phase wire-wound portion 18, and the W+-phase wire-wound portion 18.

The plurality of wire-wound portions 18 are arranged in the clockwise direction in the order of the U+-phase wire-wound portion 18, the U-phase wire-wound portion 18, the U+-phase wire-wound portion 18, the W+-phase wire-wound portion 18, the W-phase wire-wound portion 18, the W+-phase wire-wound portion 18, the V+-phase wire-wound portion 18, the V-phase wire-wound portion 18, and the V+-phase wire-wound portion 18.

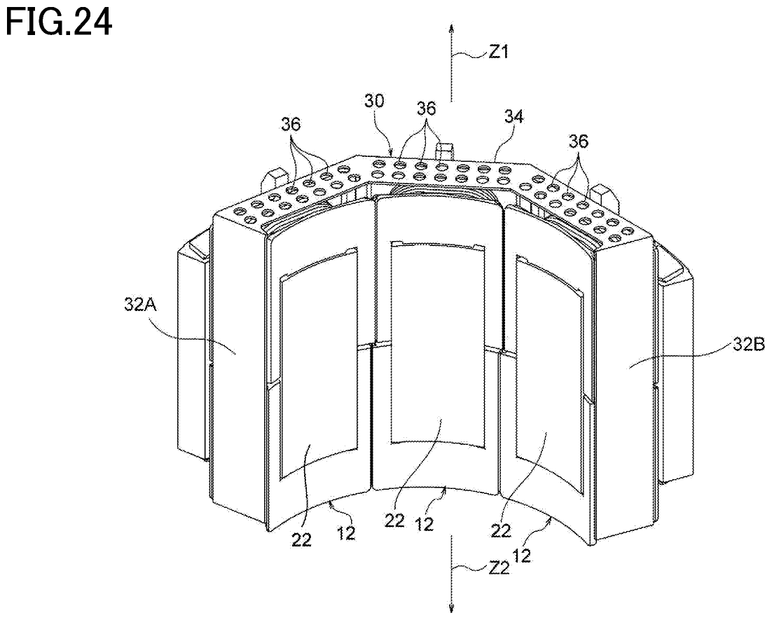

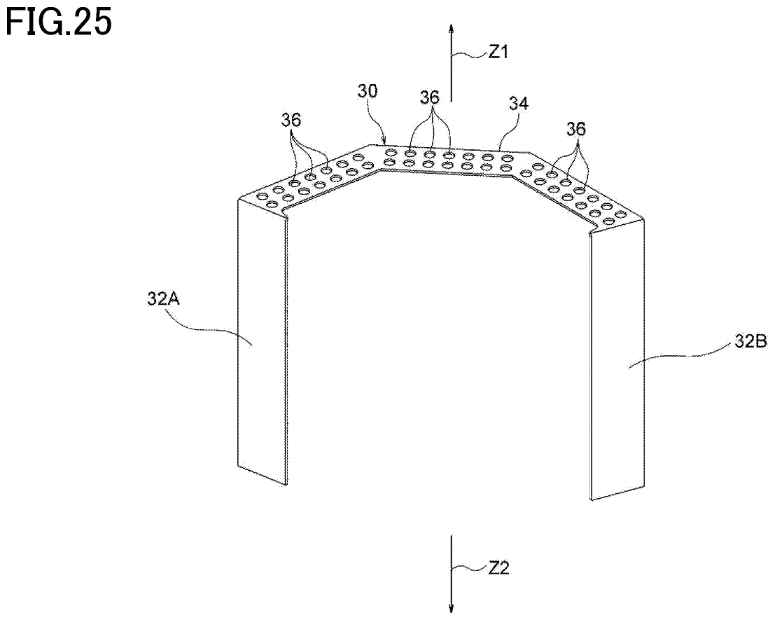

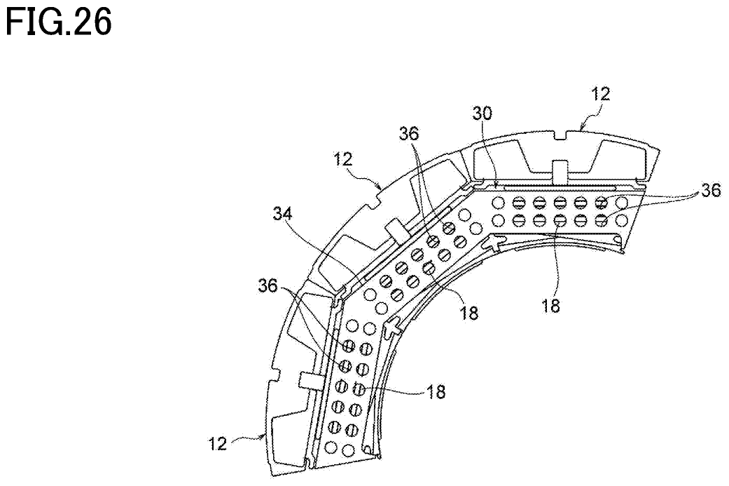

Each of the insulating members 30 is attached to a respective three of the stator core members 12 (see also FIGS. 24 to 26). In each of the insulating members 30, the first insulating portion 32A is inserted into one of the slots 28, while the second insulating portion 32B is inserted into one of the slots 28 three slots away from the slot 28 into which the first insulating portion 32A is inserted.

The plurality of insulating members 30 include the U-phase insulating member 30 attached across the U+-phase wire-wound portion 18, the U-phase wire-wound portion 18, and the U+-phase wire-wound portion 18, the V-phase insulating member 30 attached across the V+-phase wire-wound portion 18, the V—phase wire-wound portion 18, and the V+-phase wire-wound portion 18, and the W-phase insulating member 30 attached across the W+-phase wire-wound portion 18, the W—phase wire-wound portion 18, and the W+-phase wire-wound portion 18.

In the U-phase insulating member 30, the first insulating portion 32A is arranged between the U+-phase wire-wound portion 18 and the V+-phase wire-wound portion 18, and the second insulating portion 32B is arranged between the U+-phase wire-wound portion 18 and the W+-phase wire-wound portion 18.

In the V-phase insulating member 30, the first insulating portion 32A is arranged between the V+-phase wire-wound portion 18 and the W+-phase wire-wound portion 18, and the second insulating portion 32B is arranged between the V+-phase wire-wound portion 18 and the U+-phase wire-wound portion 18.

In the W-phase insulating member 30, the first insulating portion 32A is inserted into a slot 28 located between the W+-phase wire-wound portion 18 and the U+-phase wire-wound portion 18, and the second insulating portion 32B is arranged between the W+-phase wire-wound portion 18 and the V+-phase wire-wound portion 18 among the plurality of slots 28.

In this modified example as well, neither each of the first insulating portions 32A nor each of the second insulating portions 32B is arranged between the wire-wound portions 18 of the same phase. However, since a potential difference between the wire-wound portions 18 of the same phase is smaller than a potential difference between the wire-wound portions 18 of different phases, insulation between the wire-wound portions 18 of the same phase is unnecessary.

In the above-described modified example as well, since the insulation between the wire-wound portions 18 of the same phase is omitted, production costs of the stator 10 can be reduced as compared with a case where the wire-wound portions 18 of the same phase are insulated.

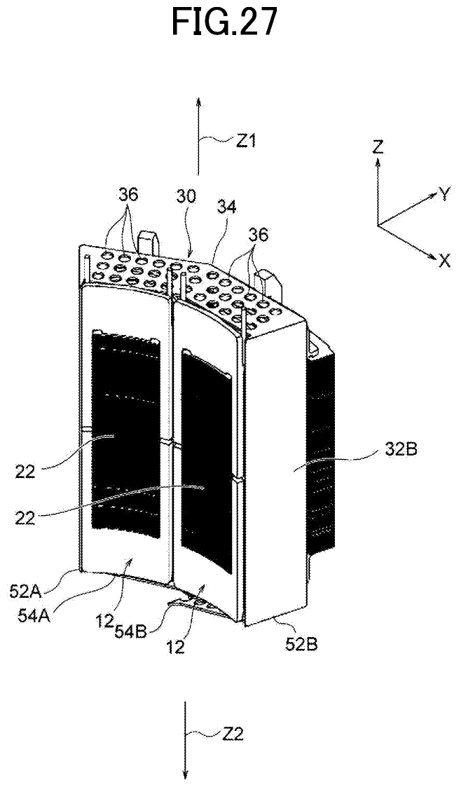

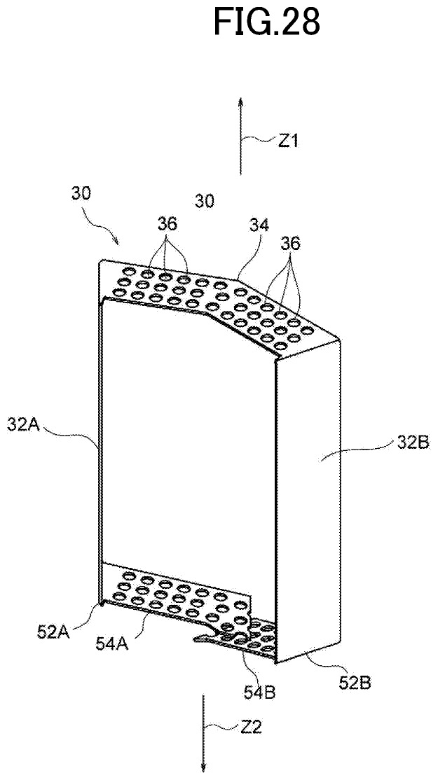

Further, as shown in FIGS. 27 and 28, similarly to the second embodiment, the first extending portion 54A extending toward the second insulating portion 32B may be formed at the first tip portion 52A of the first insulating portion 32A, and the second extending portion 54B extending toward the first insulating portion 32A may be formed at the second tip portion 52B of the second insulating portion 32B. With such a configuration, the insulating member 30 can be suppressed from detaching toward the arrow Z1-side from the stator core member 12.

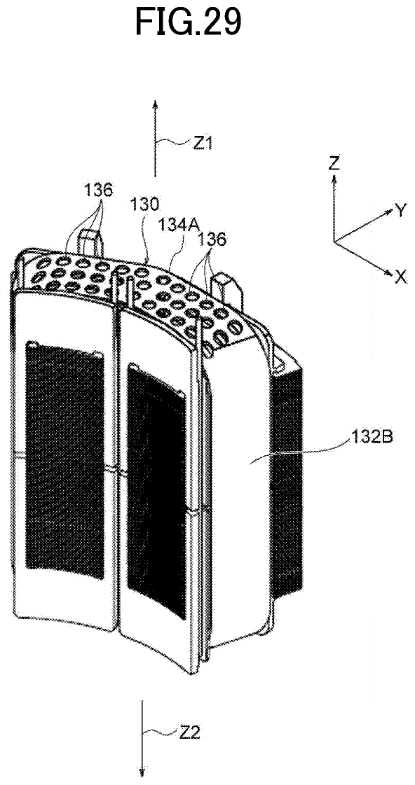

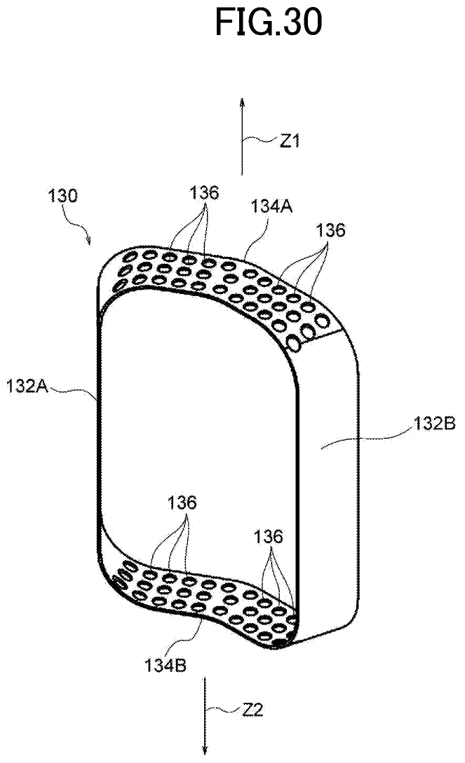

Further, as shown in FIGS. 29 and 30, in the fourth embodiment, instead of each insulating member 30, the insulating member 130, which is the heat-shrinkable tube having heat shrinkability described in the third embodiment, may be used.

### Fifth Embodiment

The stator 10 according to the fifth embodiment will be described below.

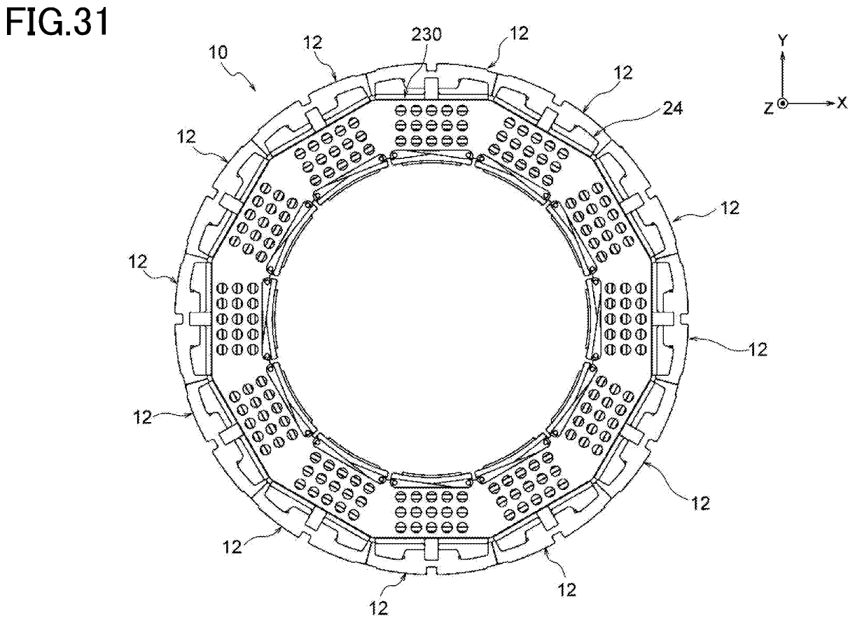

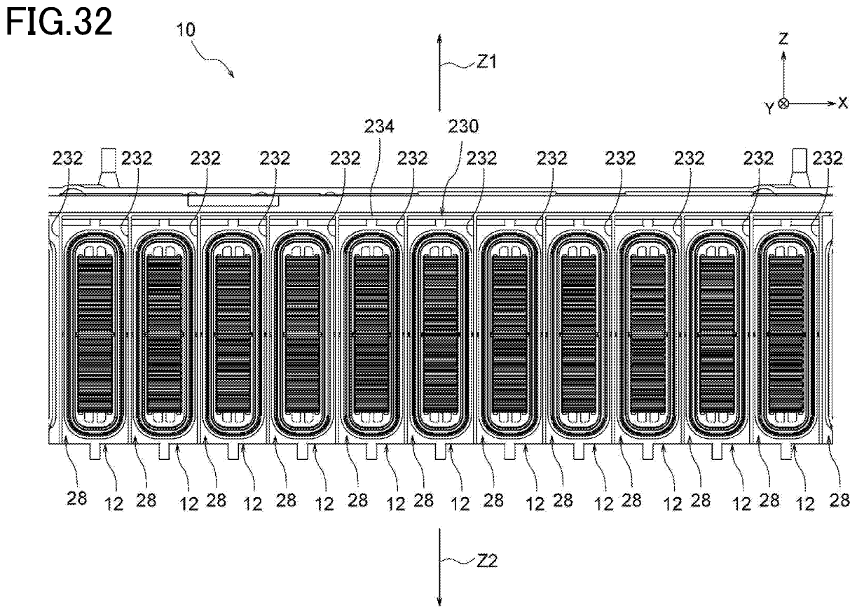

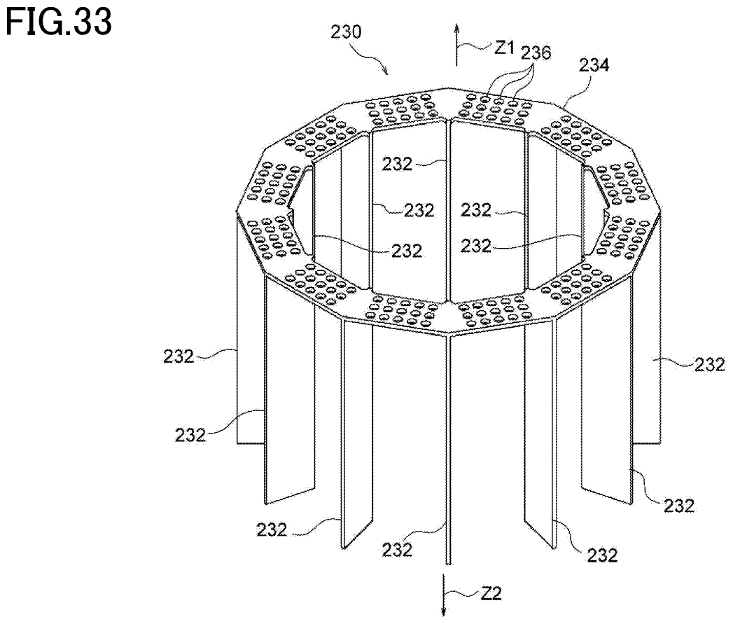

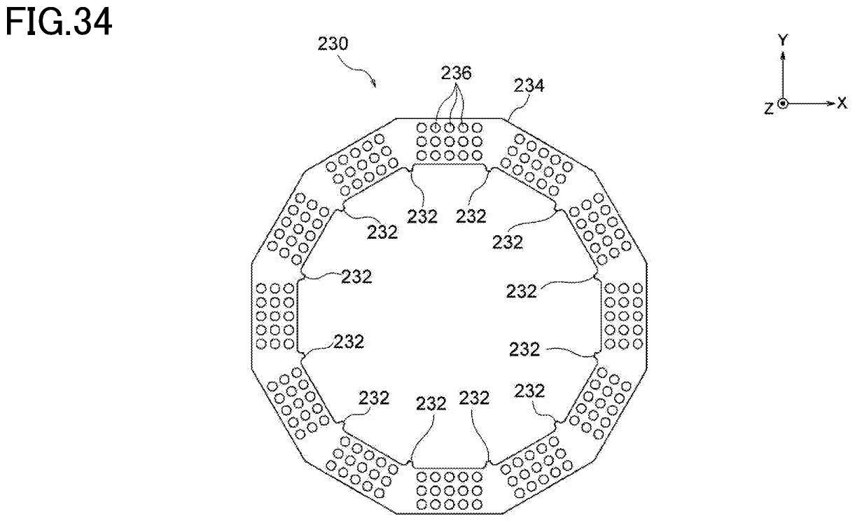

As shown in FIGS. 31 and 32, the stator 10 in the fifth embodiment i configured to have a single insulating member 230 instead of the plurality of insulating members 30 (see FIGS. 2 and 3) in the first embodiment. The insulating member 230 has a plurality of insulating portions 232 and the connecting portion 234 (see also FIGS. 33 and 34). Each of the insulating members 230 is formed of, for example, a sheet-like member made of resin having insulating properties.

The number of the plurality of insulating portions 232 is the same as the number of the plurality of slots 28. In other words, each of the insulating portions 232 is inserted into a respective one of the slots 28. The slots 28 into which the insulating portions 232 are inserted are an example of a “selected slot” in the present disclosure. Each of the insulating portions 232 extends both in the Y-direction and in the Z-direction. Each of the insulating portions disposed in a corresponding one of the slots 28 is arranged between the adjacent wire-wound portions 18 and works to insulate therebetween. The connecting portion 234 is formed in a ring shape along the circumferential direction of the stator core 24. The connecting portion 234 is arranged on the arrow Z1-side of the wire-wound portions 18, and connects ends of the insulating portions 232 on the arrow Z1-side.

The insulating member 230 is attached to the plurality of stator core members 12 from the arrow Z1-side after the plurality of stator core members 12 are combined in an annular shape. In a state where the insulating member 230 is attached to the plurality of stator core members 12, each of the insulating portions 232 is arranged along an axially extending portion of a corresponding one of the wire-wound portions 18 extending in the Z-direction, and the connecting portion 234 is arranged along tangentially extending portions of the wire-wound portions 18 extending in the X-direction.

The connecting portion 234, like in the first embodiment, has formed therein a plurality of through-holes 236 opening in the Z-direction.

In the fifth embodiment, the connecting portion 234 is formed in a ring shape, and the plurality of insulating portions 232 and the connecting portion 234 constitute the insulating member 230. Therefore, as compared with a case where the plurality of insulating members 30 are used, the number of parts and assembly man-hours for the stator 10 can be reduced, and thus production costs can be reduced.

### Sixth Embodiment

The stator 10 according to the sixth embodiment will be described below.

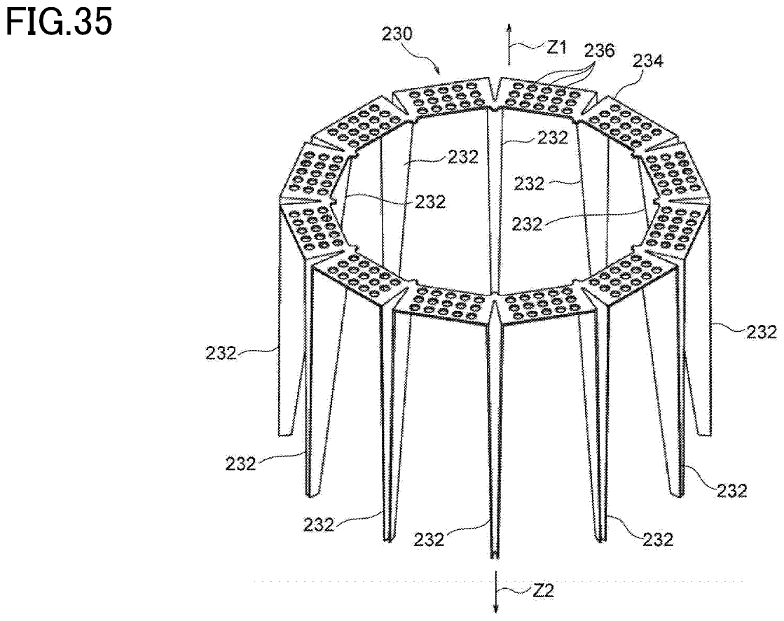

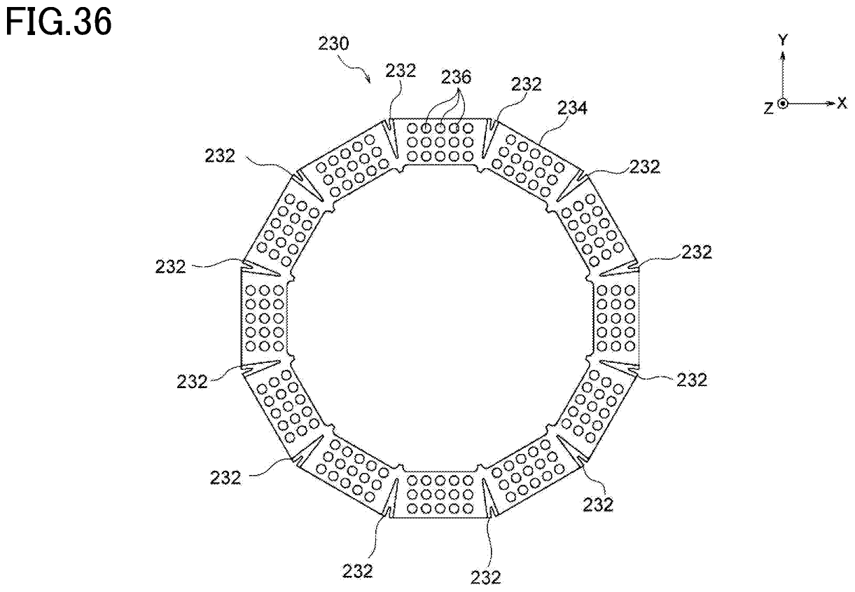

The sixth embodiment is different from the fifth embodiment only in the configuration of the insulating member 230. Specifically, as shown in FIGS. 35 and 36, the insulating members 230 includes the insulating portions 232 each of which is bent into a V-shape when viewed from the Z-direction. Specifically, each of the insulating portions 232 has the V-shape over the entire length thereof in the Z-direction.

In the sixth embodiment, each of the insulating portions 232 is, as described above, bent into a V-shape when viewed from the Z-direction. In other words, each of the insulating portions 232 has a double-wall structure, thereby increasing the rigidity thereof, which is advantageous when the insulating members 230 are attached to the stator core members 12 from the arrow Z1 side. This minimizes the risk that the insulating portions 232 may elastically bend or deform. The double-wall structure provides an increased overall thickness of each of the insulating portions 232, thereby improving insulation between the stator core members 12.

### Seventh Embodiment

The stator 10 according to the seventh embodiment will be described below.

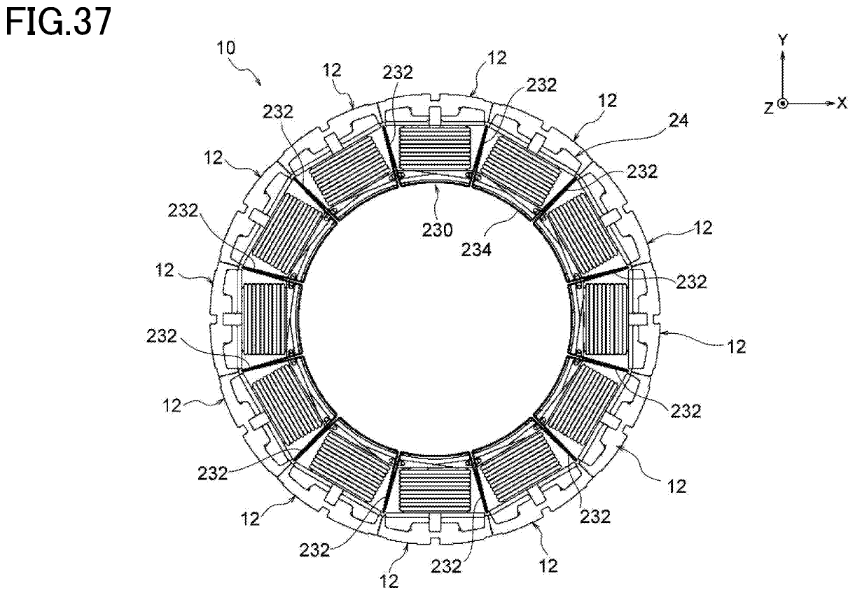

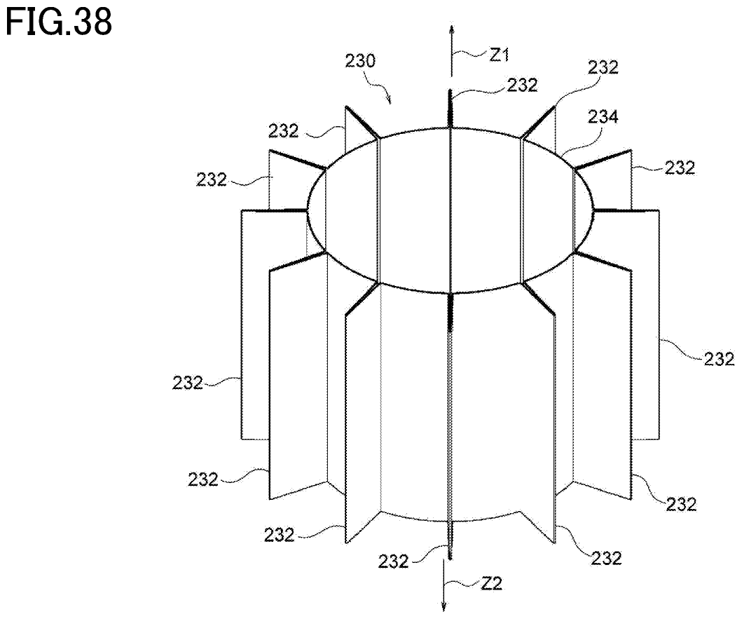

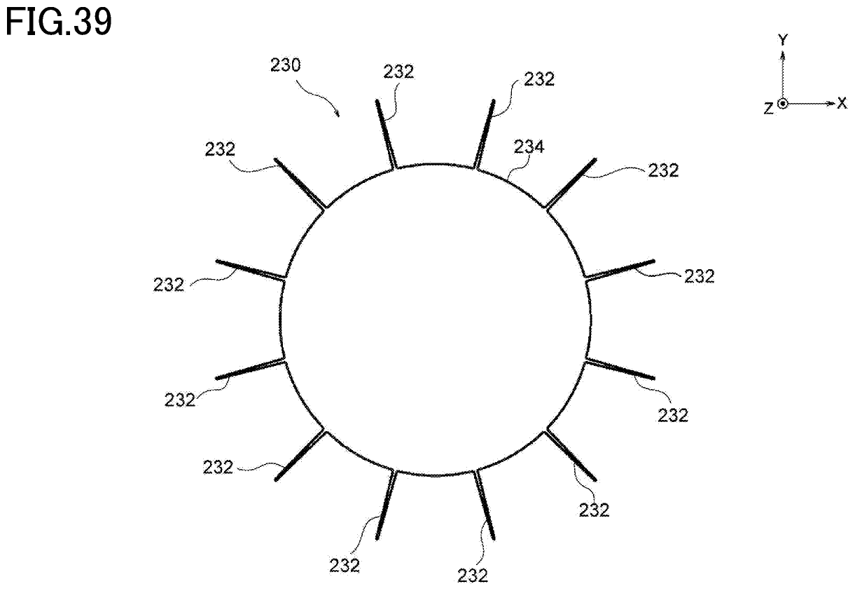

The seventh embodiment is different from the sixth embodiment only in the configuration of the insulating member 230. Specifically, as shown in FIGS. 37 to 39, the insulating member 230 has the connecting portion 234 formed in a hollow cylindrical shape along the circumferential direction of the stator core 24, and is arranged on a radially inner side of the stator core 24. Each of the insulating portions 232 extends from the connecting portion 234 toward a radially outer side of the stator core 24.

In the seventh embodiment as well, each of the insulating portions 232 is bent into a V-shape when viewed from the Z-direction. Each of the insulating portions 232 has the V-shape over the entire length in the Z-direction.

In the seventh embodiment, the connecting portion 234 is, as described above, formed in the hollow cylindrical shape along the circumferential direction of the stator core 24, and is arranged radially inside the stator core 24. Each of the insulating portions 232 extends from the connecting portion 234 radially outside the stator core 24. This enables the stator 10 to have a reduced axial length as compared with a case where the connecting portion 234 is arranged on one axial side of the stator 10.

In the seventh embodiment as well, each of the insulating portions 232, as described above, has the V-shape when viewed from the Z-direction. In other words, each of the insulating portions 232 has a double-wall structure, thereby increasing the rigidity thereof, which is advantageous when the insulating members 230 are attached to the stator core members 12 from the arrow Z1 side. This minimizes the risk that the insulating portions 232 may elastically bend or deform. The double-wall structure provides an increased overall thickness of each of the insulating portions 232, thereby improving insulation between the stator core members 12.

### Eighth Embodiment

The stator 10 according to the eighth embodiment will be described below.

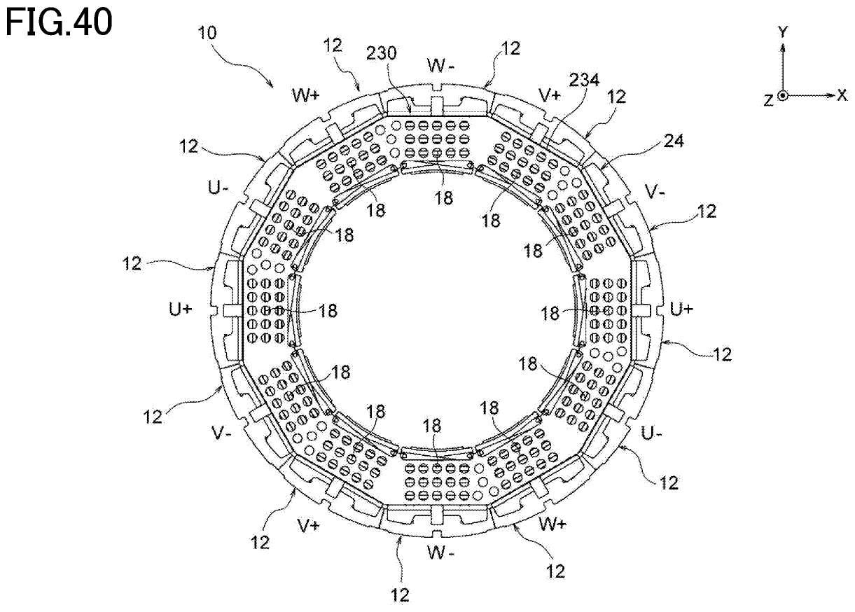

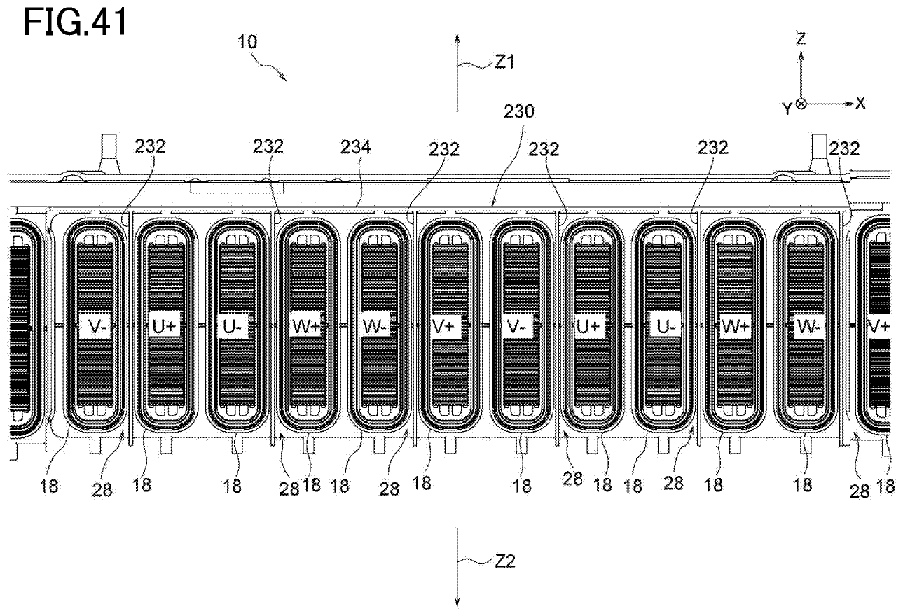

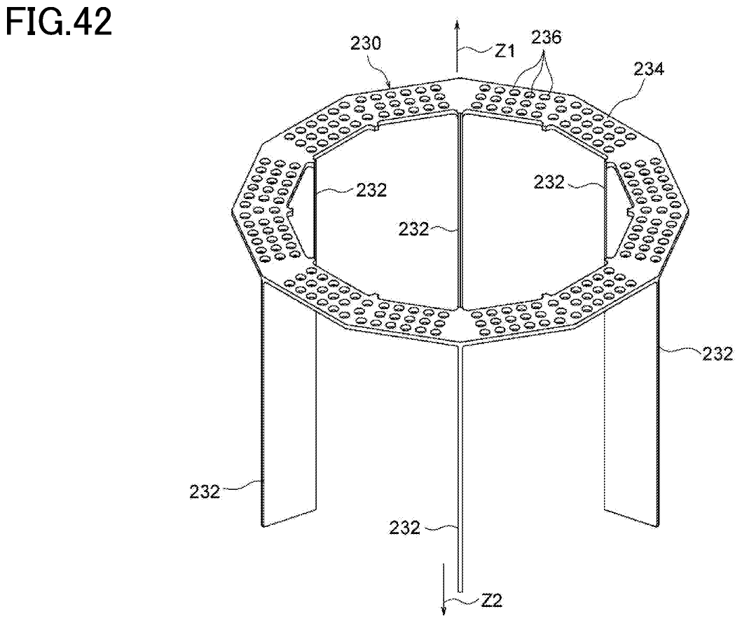

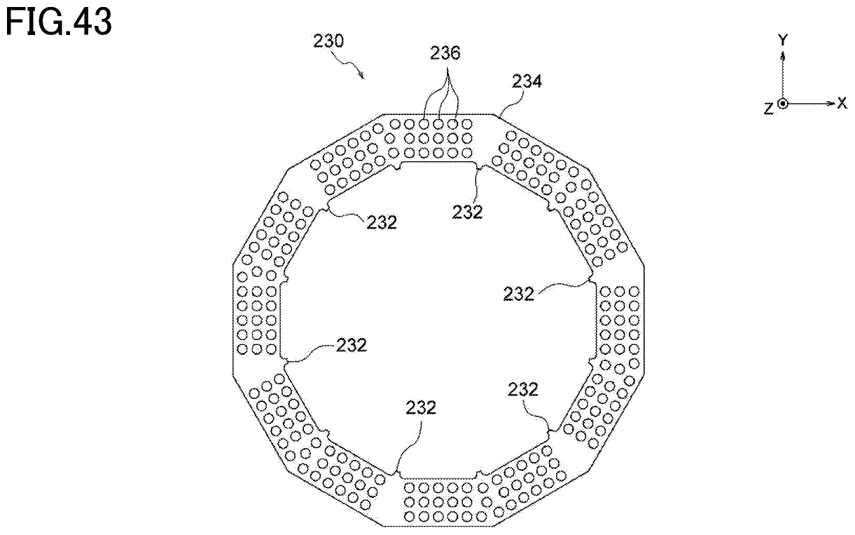

As shown in FIGS. 40 and 41, similarly to the fourth embodiment, the stator 10 in this embodiment has 10 magnetic poles and 12 slots 28. The stator 10 is different from that in the fourth embodiment in that a single insulating member 230 is used instead of the plurality of insulating members 30 (see FIGS. 18 and 19) in the fourth embodiment. The insulating member 230 includes a plurality of insulating portions 232 and the connecting portion 234 (see also FIGS. 42 and 43). The insulating member 230 is formed of, for example, a sheet-like member made of a resin having insulating properties.

The number of the insulating portions 232 is half the number of the slots 28. Each of the insulating portions 232 is inserted into a respective one of half of the slots 28. The slots 28 into which the insulating portions 232 are inserted are an example of a “selected slot” in the present disclosure. Each of the insulating portions 232 extends both in the Y-direction and in the Z-direction. In a state in which each of the insulating portions 232 is inserted into the slot 28, the insulating portion 232 is arranged between the adjacent wire-wound portions 18 and electrically insulates the adjacent wire-wound portions 18 from each other. The connecting portion 234 is formed in a ring shape along the circumferential direction of the stator core 24. The connecting portion 234 is arranged on the arrow Z1-side of the wire-wound portions 18, and connects ends of the insulating portions 232 on the arrow Z1-side.

The insulating member 230 is attached to the stator core members 12 from the arrow Z1-side after the stator core members 12 are combined in an annular shape. In a state in which the insulating member 230 is attached to the stator core members 12, each of the insulating portions 232 is arranged along axially extending portions of a corresponding adjacent two of the wire-wound portions 18 extending in the Z-direction, and the connecting portion 234 is arranged along tangentially extending portions of the wire-wound portions 18 in the X-direction.

The connecting portion 234, like in the first embodiment, has formed therein a plurality of through-holes 236 opening in the Z-direction.

More specifically, the insulating portions 232 are respectively arranged between the U+-phase wire-wound portion 18 and the V-phase wire-wound portion 18, between the U-phase wire-wound portion 18 and the W+-phase wire-wound portion 18, between the V+-phase wire-wound portion 18 and the W-phase wire-wound portion 18, between the V-phase wire-wound portion 18 and the U+-phase wire-wound portion 18, between the W+-phase wire-wound portion 18 and the U—phase wire-wound portion 18, and between the W-phase wire-wound portion 18 and the V+-phase wire-wound portion 18.

In the eighth embodiment, no insulating portion is arranged between the wire-wound portions 18 of the same phase. However, a potential difference between the wire-wound portions 18 of the same phase is smaller than that between the wire-wound portions 18 of different phases, thereby eliminating the need for insulation between the wire-wound portions 18 of the same phase.

The connecting portion 234, like in the first embodiment has formed therein a plurality of through-holes 236 opening in the Z-direction.

In the eighth embodiment, insulation between the wire-wound portions 18 of the same phase is omitted, thereby reducing production costs of the stator 10 as compared with a case in which the wire-wound portions 18 of the same phase are electrically insulated from each other.

The connecting portion 234 is, as described above, formed in a ring shape, and the plurality of insulating portions 232 and the connecting portion 234 constitute the single insulating member 230. These arrangements enable the number of parts of the stator 10 and assembly man-hours for the stator 10 to be reduced, thereby reducing production costs of the stator 10, as compared with a case in which a plurality of the insulating members 330 are used.

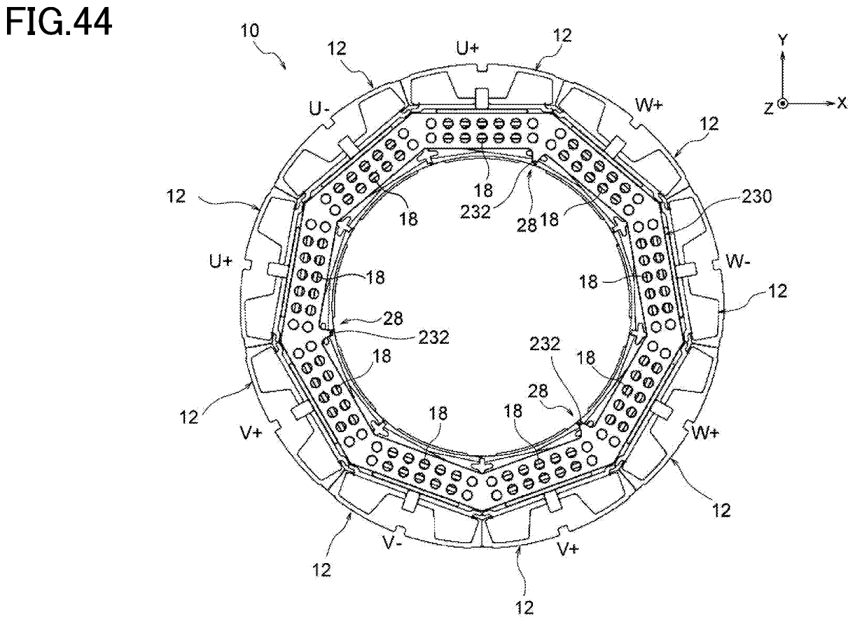

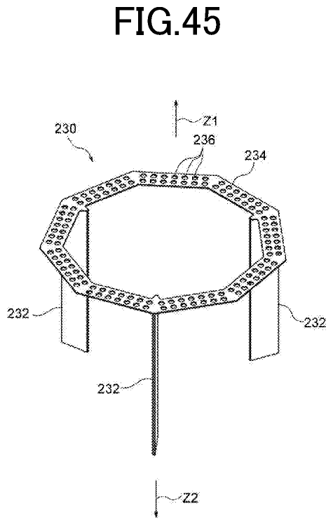

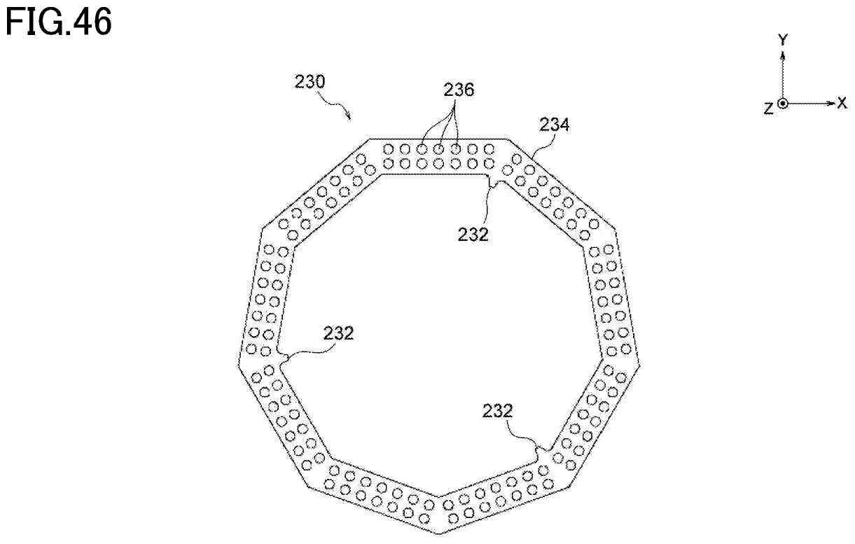

The stator 10, as described above, has the 10 magnetic poles and the 12 slots 28. However, as shown in FIG. 44, the stator 10 may be designed to have 8 magnetic poles and 9 slots 28. The plurality of insulating portions 232 (see also FIGS. 45 and 46) may be respectively arranged between the U+-phase wire-wound portion 18 and the V+-phase wire-wound portion 18, between the U+-phase wire-wound portion 18 and the W+-phase wire-wound portion 18, and between the V+-phase wire-wound portion 18 and the W+-phase wire-wound portion 18.

In this modified example as well, no insulating portion 232 is arranged between the wire-wound portions 18 of the same phase. However, a potential difference between the wire-wound portions 18 of the same phase is smaller than that between the wire-wound portions 18 of different phases, thereby eliminating the need for insulation between the wire-wound portions 18 of the same phase.

In this modified example as well, insulation between the wire-wound portions 18 of the same phase is omitted, thereby reducing production costs of the stator 10 as compared with a case where the wire-wound portions 18 of the same phase are electrically insulated.

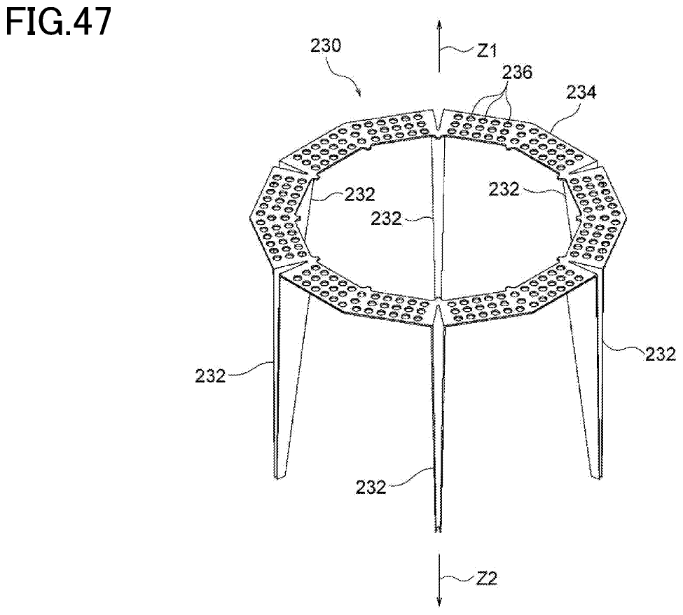

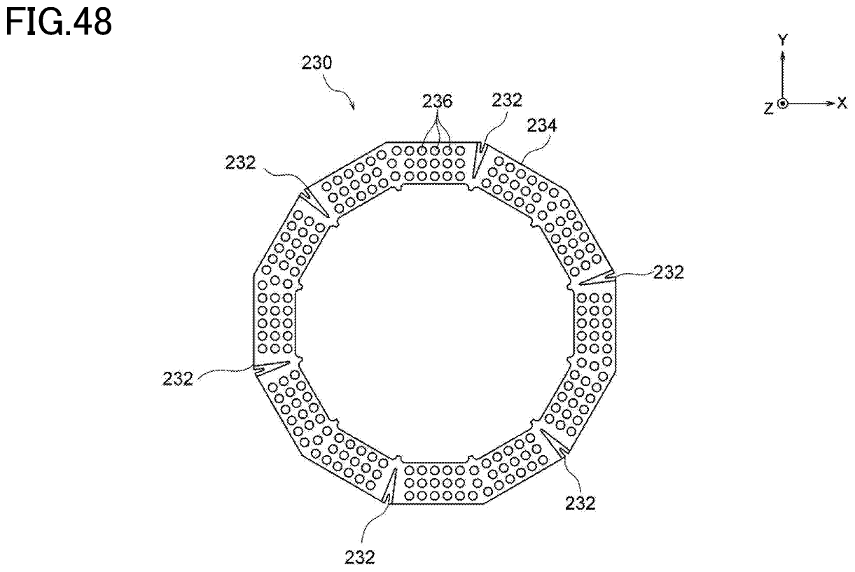

Each of the insulating portions 232 may be, as illustrated in FIGS. 47 and 48, bent into a V-shape when viewed from the Z-direction. Each of the insulating portions 232 may also be bent into the V-shape over the entire length thereof in the Z-direction.

Each of the insulating portions 232, as described above, has the V-shape when viewed from the Z-direction. In other words, each of the insulating portions 232 has a double-wall structure, thereby increasing the rigidity thereof, which is advantageous when the insulating members 230 are attached to the stator core members 12 from the arrow Z1 side. This minimizes the risk that the insulating portions 232 may elastically bend or deform. The double-wall structure provides an increased overall thickness of each of the insulating portions 232, thereby improving insulation between the stator core members 12.

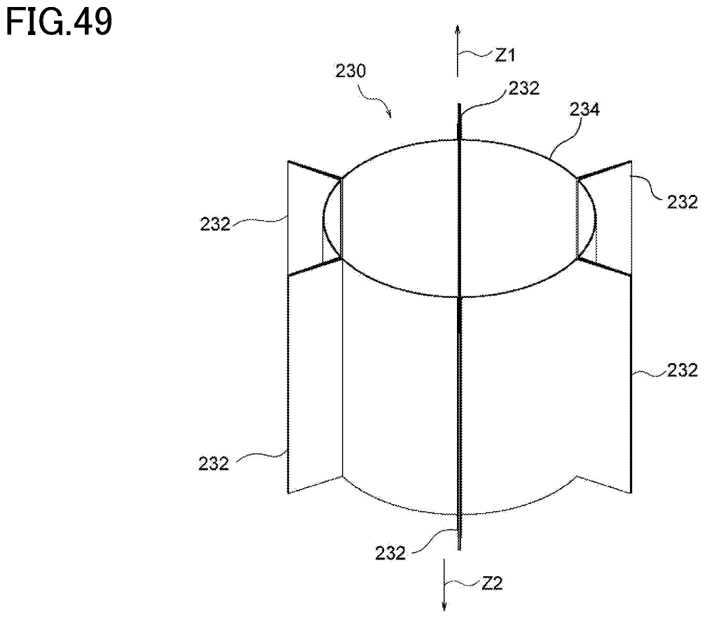

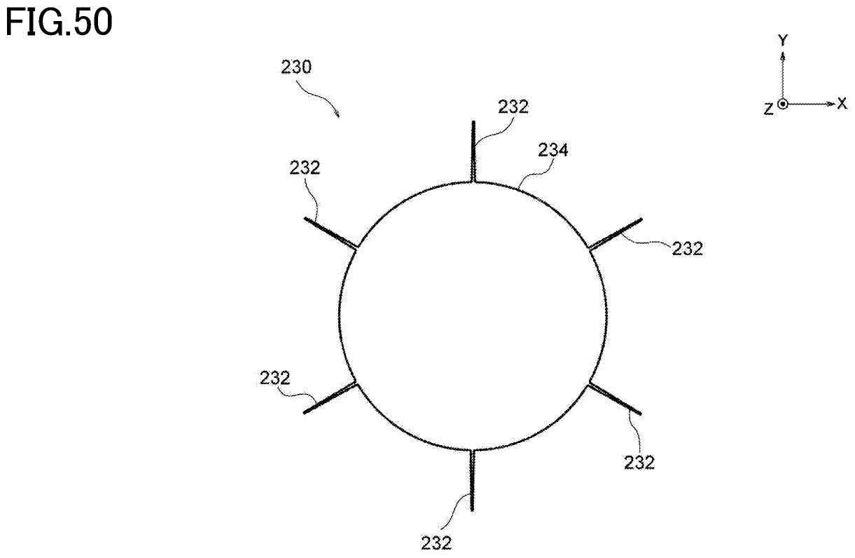

Further, as shown in FIGS. 49 and 50, the connecting portion 234 may be formed in a hollow cylindrical shape along the circumferential direction of the stator core 24 (see FIG. 37 or the like) described above, and may be arranged on a radially inner side of the stator core 24. Each of the insulating portions 232 may extend from the connecting portion 234 toward a radially outer side of the stator core 24. Furthermore, each of the insulating portions 232 may be bent into a V-shape when viewed from the Z-direction. For example, each of the insulating portions 232 may be bent into the V-shape over the entire length thereof in the Z-direction.

The connecting portion 234 is, as described above, formed in the hollow cylindrical shape along the circumferential direction of the stator core 24, and is arranged radially inside the stator core 24. Each of the insulating portions 232 extends from the connecting portion 234 radially outside the stator core 24. This enables the stator 10 to have a reduced axial length as compared with a case in which the connecting portion 234 is arranged on the one axial side of the stator 10.

Each of the insulating portions 232, as described above, has the V-shape when viewed from the Z-direction. In other words, each of the insulating portions 232 has a double-wall structure, thereby increasing the rigidity thereof, which is advantageous when the insulating members 230 are attached to the stator core members 12 from the arrow Z1 side. This minimizes the risk that the insulating portions 232 may elastically bend or deform. The double-wall structure provides an increased overall thickness of each of the insulating portions 232, thereby improving insulation between the stator core members 12.

### Ninth Embodiment

The stator 10 according to the ninth embodiment will be described below.

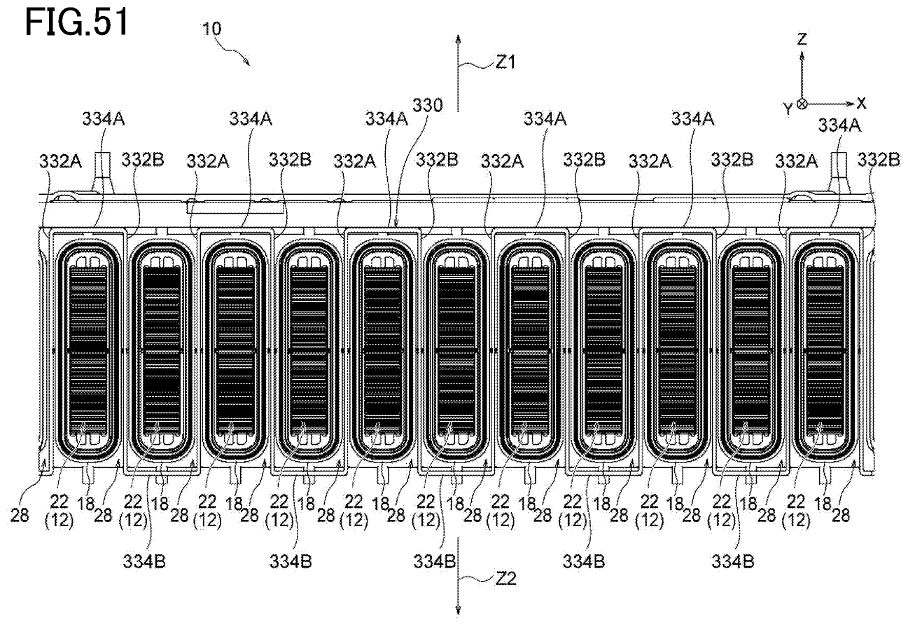

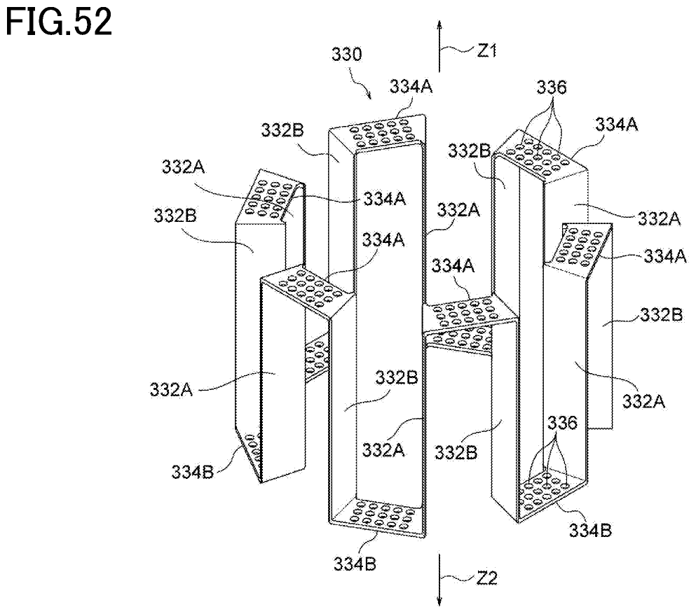

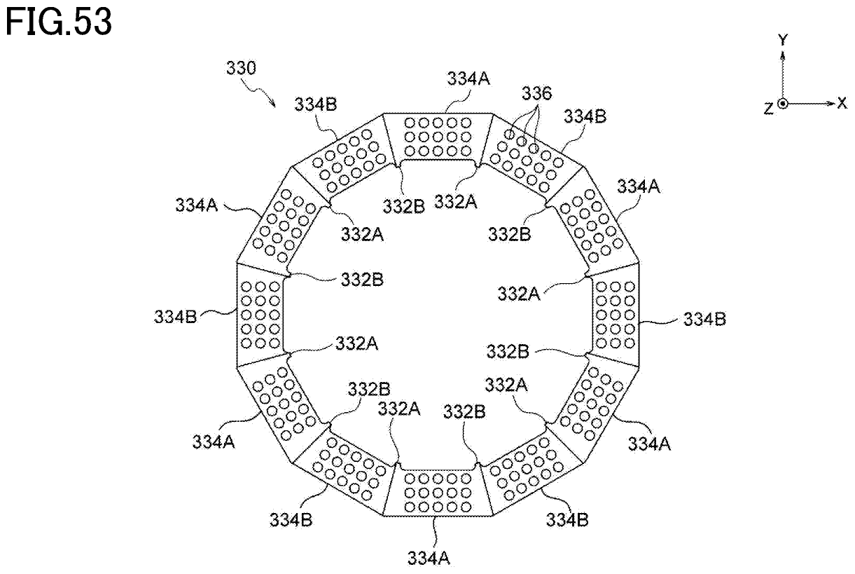

As shown in FIG. 51, the stator 10 in the ninth embodiment is configured to have a single insulating member 330 instead of the plurality of insulating members 30 (see FIGS. 2 and 3) in the first embodiment. The insulating member 330 includes a plurality of first insulating portions 332A, a plurality of second insulating portions 332B, a plurality of first connecting portions 334A, and a plurality of second connecting portions 334B (see also FIGS. 52 and 53). The first insulating portions 332A and the second insulating portions 332B are an example of a “plurality of insulating portions” in the present disclosure. The first connecting portions 334A and the second connecting portions 334B are an example of a “connecting portion” in the present disclosure.

The insulating member 330 includes the first insulating portions 332A, the second insulating portions 332B, the first connecting portions 334A, and the second connecting portions 334B, which are repeatedly and continuously arranged in the order of the first insulating portion 332A, the first connecting portion 334A, the second insulating portion 332B, and the second connecting portion 334B. The insulating member 330 is formed of, for example, a sheet-like member made of a resin having insulating properties.

The total number of the first insulating portions 332A and the second insulating portions 332B is the same as that of the slots 28. The first insulating portions 332A and the second insulating portions 332B are alternately inserted, one into each of the slots 28. In other words, each of the first insulating portions 332A is inserted into one of the slots 28, while each of the second insulating portions 332B is inserted into one of the slots 28 which is adjacent to the slot 28 into which the first insulating portion 332A is inserted. The slot 28 into which each of the first insulating portions 332A is inserted is an example of a “selected slot” and a “first selected slot” in the present disclosure, and the slot 28 into which each of the second insulating portions 332B is inserted is an example of a “selected slot” and a “second selected slot” in the present disclosure.

The first insulating portions 332A extend both in the Y-direction and in the Z-direction. In a state in which each of the first insulating portions 332A is inserted into one of the slots 28, the first insulating portion 332A is arranged between the adjacent wire-wound portions 18 and electrically insulates the adjacent wire-wound portions 18 from each other. Similarly, each of the second insulating portions 332B extends both in the Y-direction and in the Z-direction. In a state in which each of the second insulating portions 332B is inserted into one of the slots 28, the second insulating portion 332B is arranged between the adjacent wire-wound portions 18 and electrically insulates the adjacent wire-wound portions 18 from each other.

The first connecting portions 334A extend both in the X-direction and in the Y-direction. Each of the first connecting portions 334A is arranged on the arrow Z1-side of a corresponding one of the wire-wound portions 18, and connects an end of a corresponding one of the first insulating portions 332A on the arrow Z1-side and an end of an adjacent one of the second insulating portions 332B on the arrow Z1-side to each other. The second connecting portions 334B extend both in the X-direction and in the Y-direction. Each of the second connecting portions 334B is arranged on the arrow Z2-side of a corresponding one of the wire-wound portions 18, and connects an end (also referred to as a second end) of a corresponding one of the first insulating portions 332A on the arrow Z2-side and an end (also referred to as a second end) of an adjacent one of the second insulating portions 332B on the arrow Z2-side to each other.

The insulating member 330 is attached to the stator core members 12 from a tip side of the teeth 22 described above in a state in which the stator core members 12 are arranged linearly. The stator core members 12 are formed into an annular shape after the insulating member 330 is attached thereto. The insulators 16 (see FIG. 1) of the adjacent stator core members 12 may be connected to each other. In a state in which the insulating member 330 is attached to the stator core members 12, the first insulating portions 332A and the second insulating portions 332B are arranged along axially extending portions of the adjacent wire-wound portions 18 extending in the Z-direction, while the first connecting portions 334A and the second connecting portions 334B are arranged along tangentially extending portions of the corresponding wire-wound portions 18 extending in the X-direction.

The first connecting portions 334A and the second connecting portions 334B, like in the first embodiment, have formed therein a plurality of through-holes 336 opening in the Z-direction.

In the ninth embodiment, the first insulating portions 332A, the second insulating portions 332B, the first connecting portions 334A, and the second connecting portions 334B are, as described above, repeatedly and continuously arranged in the order of the first insulating portion 332A, the first connecting portion 334A, the second insulating portion 332B, and the second connecting portion 334B, thereby constituting the insulating member 330. These arrangements enable the number of parts of the stator 10 and assembly man-hours for the stator 10 to be reduced, thereby reducing production costs of the stator 10, as compared with a case in which a plurality of the insulating members 330 are used.

### Tenth Embodiment

The stator 10 according to the tenth embodiment will be described below.

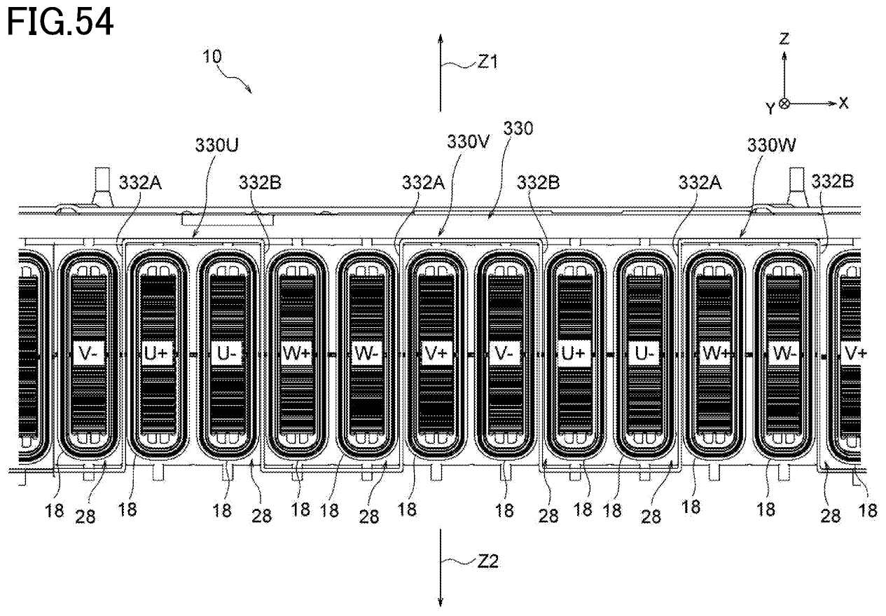

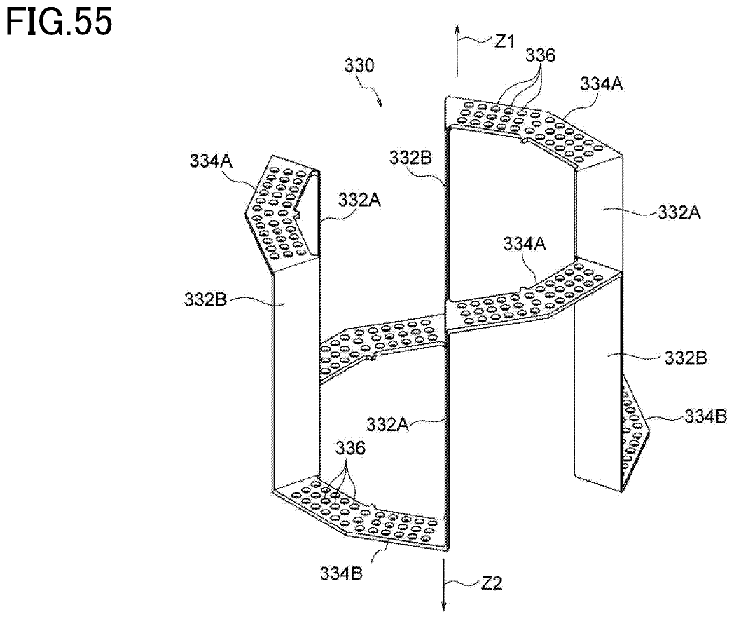

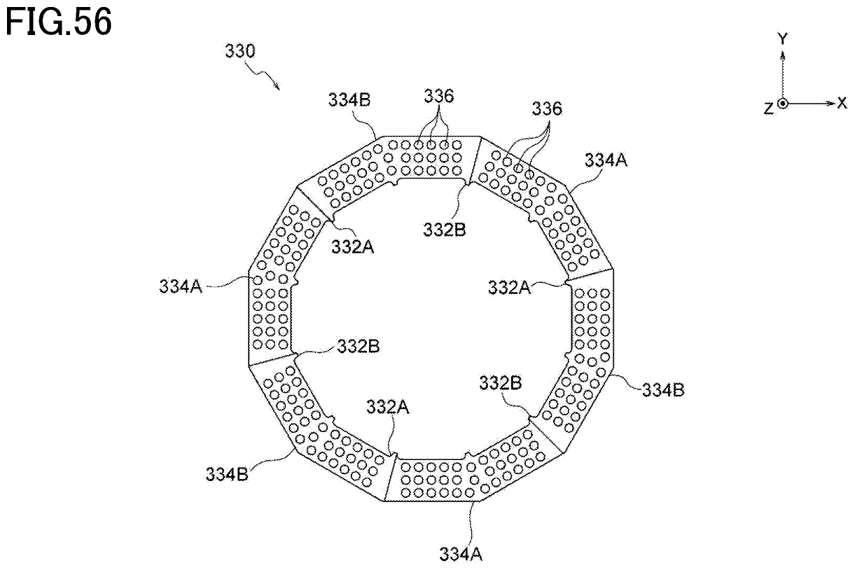

As shown in FIG. 54, similarly to the fourth embodiment, the stator 10 according to the tenth embodiment has 10 magnetic poles and 12 slots 28. The tenth embodiment is different from the ninth embodiment only in the configuration of the insulating member 330 (see also FIGS. 55 and 56)

Specifically, the insulating member 330 has the U-phase insulating attachment portions 330U each of which is attached across the U+-phase wire-wound portion 18 and the U-phase wire-wound portion 18, the V-phase insulating attachment portions 330V each of which is attached across the V+-phase wire-wound portion 18 and the V-phase wire-wound portion 18, and the W-phase insulating attachment portions 330W each of which is attached across the W+-phase wire-wound portion 18 and the W-phase wire-wound portion 18.

In each of the U-phase insulating attachment portions 330U, the first insulating portion 332A is arranged between the U+-phase wire-wound portion 18 and the V-phase wire-wound portion 18, and the second insulating portion 332B is arranged between the U-phase wire-wound portion 18 and the W+-phase wire-wound portion 18.

In each of the V-phase insulating attachment portions 330V, the first insulating portion 332A is arranged between the V+-phase wire-wound portion 18 and the W-phase wire-wound portion 18, and the second insulating portion 332B is arranged between the V-phase wire-wound portion 18 and the U+-phase wire-wound portion 18.

In each of the W-phase insulating attachment portions 330W, the first insulating portion 332A is arranged between the W+-phase wire-wound portion 18 and the U-phase wire-wound portion 18, and the second insulating portion 332B is arranged between the W-phase wire-wound portion 18 and the V+-phase wire-wound portion 18.

In the tenth embodiment, neither the first insulating portions 332A nor the second insulating portions 332B are arranged between the wire-wound portions 18 of the same phase. However, a potential difference between the wire-wound portions 18 of the same phase is smaller than a potential difference between the wire-wound portions 18 of different phases, thereby eliminating the need for insulation between the wire-wound portions 18 of the same phase.

The first connecting portions 334A and the second connecting portions 334B, like in the first embodiment, have a plurality of through-holes 336 opening in the Z-direction.

In the tenth embodiment, electrical insulation between the wire-wound portions 18 of the same phase is omitted, thereby reducing production costs of the stator 10, as compared with a case in which the wire-wound portions 18 of the same phase are electrically insulated.

### Eleventh Embodiment

The Stator 10 according to the eleventh embodiment will be described below.

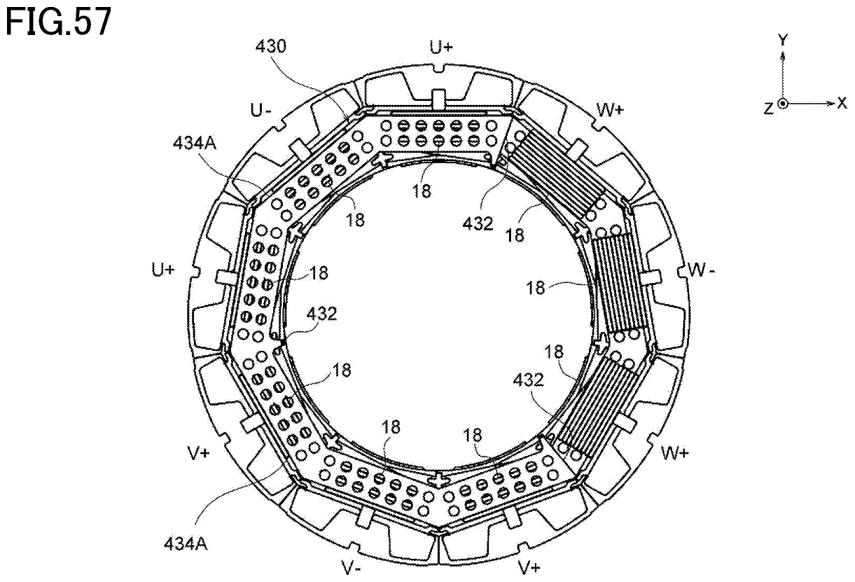

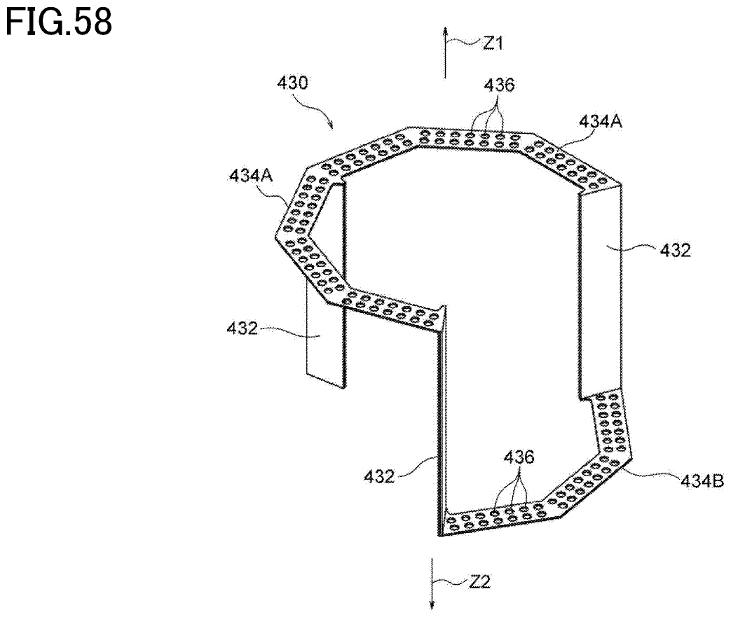

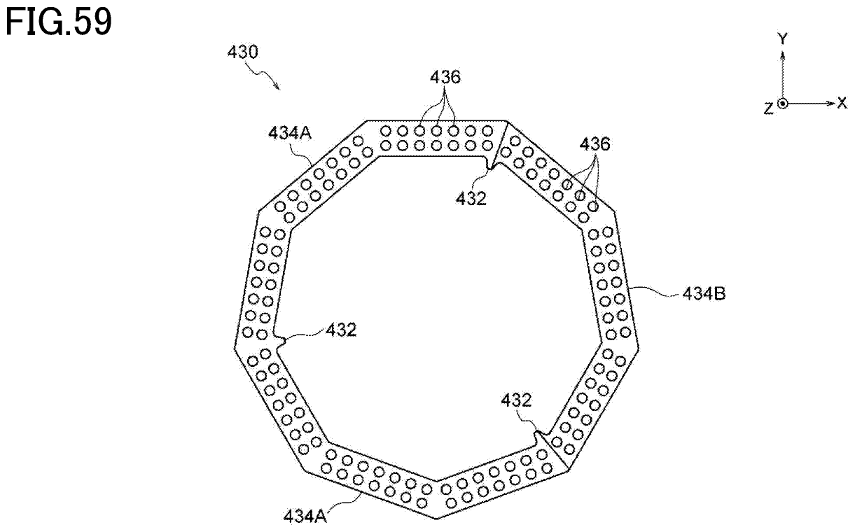

As shown in FIG. 57, similarly to the first modified example of the eighth embodiment (see FIG. 44), the stator 10 according to the eleventh embodiment has 8 magnetic poles and 9 slots 28. The stator 10 in this embodiment uses the insulating member 430 instead of the insulating member 230 in the first modified example of the eighth embodiment (see also FIGS. 58 and 59).

The insulating member 430 includes a plurality of insulating portions 432, a plurality of first connecting portions 434A, and a second connecting portion 434B. The first connecting portions 434A and the second connecting portion 434B are an example of a “connecting portion” in the present disclosure. The number of the plurality of first connecting portions 434A is two. The plurality of insulating portions 432 are respectively arranged between the U+-phase wire-wound portion 18 and the V+-phase wire-wound portion 18, between the U+-phase wire-wound portion 18 and the W+-phase wire-wound portion 18, and between the V+-phase wire-wound portion 18 and the W+-phase wire-wound portion 18.

Each of the first connecting portions 434A is arranged on the arrow Z1-side of the wire-wound portions 18, and connects first ends of a corresponding adjacent two of the insulating portions 432 on the arrow Z1-side to each other. The second connecting portion 434B is arranged on the arrow Z2-side of the corresponding wire-wound portions 18 and connects second ends of a corresponding adjacent two of the insulating portions 432 on the arrow Z2-side to each other.

The stator 10 in the eleventh embodiment is designed not to have an insulating portion arranged between the wire-wound portions 18 of the same phase. However, a potential difference between the wire-wound portions 18 of the same phase is smaller than that between the wire-wound portions 18 of different phases, thereby eliminating the need for insulation between the wire-wound portions 18 of the same phase.

The first connecting portion 434A and the second connecting portion 434B, like in the first embodiment, each have formed therein a plurality of through-holes 436 opening in the Z-direction.

In the eleventh embodiment, electrical insulation between the wire-wound portions 18 of the same phase is omitted, thereby reducing production costs of the stator 10, as compared with a case in which the wire-wound portions 18 of the same phase are electrically insulated.

The above-described embodiments and modifications may be combined with one another, provided that no inconsistency arises.

Although the present disclosure has been described with reference to the embodiments above, the present disclosure is not limited thereto. It should be understood that various modifications and changes may be made without departing from the spirit and scope of the present disclosure.

This Disclosure Provides the Following Beneficial Aspects.

### First Aspect

A stator (10) comprising: (a) a stator core (24) that includes a plurality of teeth extending in a radial direction of the stator core and a plurality of slots (28) formed between the teeth; (b) insulators (16) installed in the stator core; (c) a plurality of wire-wound portions (18) each of which is wound around a respective one of the teeth through a corresponding one of the insulators; and (d) an insulating member (30, 130, 230, 330, 430) that includes a plurality of insulating portions (32A, 32B, 132A, 132B, 232, 332A, 332B, 432) inserted into selected ones of the slots and a connecting portion (34, 134A, 134B, 234, 334A, 334B, 434A, 434B), each of the insulating portions electrically insulating an adjacent two of the wire-wound portions from each other, the connecting portion connecting the insulating portions.

### Second Aspect

The stator as set forth in the above-described first aspect, wherein the insulating member includes a plurality of insulating members (30) each of which includes, as the insulating portions, a first insulating portion (32A) and a second insulating portion (32B). Each of the first insulating portions is inserted into a first selected slot that is one of the selected slots. Each of the second insulating portions is inserted into a second selected slot that is one of the selected slots. Each of the connecting portions (34) connects first ends of a corresponding one of the first insulating portions and a corresponding one of the second insulating portions to each other, the first ends facing in an axial direction of the stator core.

### Third Aspect

The stator as set forth in the above-described second aspect, wherein the second selected slots are arranged adjacent to the first selected slots, respectively.

### Fourth Aspect

The stator as set forth in the above-described second or third aspect, wherein each of the first insulating portions (32A) has a first tip portion (52A) located opposite to a corresponding one of the connecting portions. Each of the second insulating portions (32B) has a second tip portion (52B) located opposite to a corresponding one of the connecting portions. The connecting portions (34) are arranged on a first side of the wire-wound portions in the axial direction of the stator core. Each of the first tip portions includes a first extending portion (54A) that is located on a second side of a corresponding one of the wire-wound portions in the axial direction of the stator core and extends toward a corresponding one of the second insulating portions. Each of the second tip portions includes a second extending portion (54B) that is located on the second side of a corresponding one of the wire-wound portions in the axial direction of the stator core and extends toward a corresponding one of the first insulating portions.

### Fifth Aspect

The stator as set forth in the above-described first aspect, wherein the insulating member includes a plurality of insulating members (30) each of which is formed of a tube having heat shrinkability. Each of the insulating members includes, as the insulating portions, a first insulating portion (132A) and a second insulating portion (132B) and also includes, as the connecting portions, a first connecting portion (134A) and a second connecting portion (134B). Each of the first insulating portions is inserted into a first selected slot that is one of the selected slots. Each of the second insulating portions is inserted into a second selected slot that is one of the selected slots. Each of the first connecting portions connects first ends of a corresponding one of the first insulating portions and a corresponding one of the second insulating portions. Each of the second connecting portions connects second ends of a corresponding one of the first insulating portions and a corresponding one of the second insulating portions.

### Sixth Aspect

The stator as set forth in the above-described first aspect, wherein the insulating member includes a plurality of insulating members (30). The plurality of wire-wound portions include a plurality of U-phase wire-wound portions, a plurality of V-phase wire-wound portions, and a plurality of W-phase wire-wound portions. The plurality of the insulating members include U-phase insulating members attached across the U-phase wire-wound portions, V-phase insulating members attached across the V-phase wire-wound portions, and W-phase insulating members attached across the W-phase wire-wound portions. Each of the U-phase insulating members, each of the V-phase insulating members, and each of the W-phase insulating members has a first insulating portion (32A) and a second insulating portion (32B) as the plurality of insulating portions. In each of the U-phase insulating members, the first insulating portion is arranged between a corresponding one of the U-phase wire-wound portions and a corresponding one of the V-phase wire-wound portions, and the second insulating portion is arranged between a corresponding one of the U-phase wire-wound portions and a corresponding one of the W-phase wire-wound portions. In each of the V-phase insulating members, the first insulating portion is arranged between a corresponding one of the V-phase wire-wound portions and a corresponding one of the W-phase wire-wound portions, and the second insulating portion is arranged between a corresponding one of the V-phase wire-wound portions and a corresponding one of the U-phase wire-wound portions. In each of the W-phase insulating members, the first insulating portion is arranged between a corresponding one of the W-phase wire-wound portions and a corresponding one of the U-phase wire-wound portions, and the second insulating portion is arranged between a corresponding one of the W-phase wire-wound portions and a corresponding one of the V-phase wire-wound portions.

### Seventh Aspect

The stator as set forth in the above-described first aspect, wherein the connecting portion (234) is formed in a ring shape along a circumferential direction of the stator core.

### Eighth Aspect

The stator as set forth in the above-described first or seventh aspect, wherein the insulating member (230) is formed of a sheet material, and each of the insulating portions (232) is of a V-shape when viewed from an axial direction of the stator core.

### Ninth Aspect

The stator as set forth in the above-described first aspect, wherein the connecting portion (230) is formed in a hollow cylindrical shape along a circumferential direction of the stator core and is arranged on a radially inner side of the stator core, and each of the insulating portions (232) extends from the connecting portion toward a radially outer side of the stator core.

### Tenth Aspect

The stator as set forth in the above-described first or ninth aspect, wherein the insulating member (230) is formed of a sheet material, and each of the insulating portions (232) is of a V-shape when viewed from an axial direction of the stator core.

### Eleventh Aspect

The stator as set forth in the above-described first aspect, wherein the wire-wound portions include a plurality of U-phase wire-wound portions, a plurality of V-phase wire-wound portions, and a plurality of W-phase wire-wound portions. The insulating portions (232) are respectively arranged between the U-phase wire-wound portion and the V-phase wire-wound portion, between the U-phase wire-wound portion and the W-phase wire-wound portion, and between the V-phase wire-wound portion and the W-phase wire-wound portion. The connecting portion (234) is formed in a ring shape along a circumferential direction of the stator core.

### Twelfth Aspect

The stator as set forth in the above-described first aspect, wherein the insulating member (330) includes first insulating portions (332A) and second insulating portions (332B), as the plurality of insulating portions, and the connecting portion includes first connecting portions (334A) and second connecting portions (334B). The first insulating portions, the first connecting portions, the second insulating portions, and the second connecting portions are repeatedly and continuously arranged in order of the first insulating portion, the first connecting portion, the second insulating portion, and the second connecting portion. The first insulating portions are inserted into first selected slots that are selected ones of the slots. The second insulating portions are inserted into second selected slots each of which is adjacent to one of the first selected slots. The first connecting portions are arranged on a first side of the wire-wound portions in an axial direction of the stator core. The second connecting portions are arranged on a second side of the wire-wound portions in the axial direction of the stator core.

### Thirteenth Aspect

The stator as set forth in the above-described first aspect, wherein the wire-wound portions include a plurality of U-phase wire-wound portions, a plurality of V-phase wire-wound portions, and a plurality of W-phase wire-wound portions. The insulating member (330) includes first insulating portions (332A) and second insulating portions (332B) as the insulating portions, The connecting portion includes first connecting portions (334A) and second connecting portions (334B). The first insulating portions, the first connecting portions, the second insulating portions, and the second connecting portions are repeatedly and continuously arranged in order of the first insulating portion, the first connecting portion, the second insulating portion, and the second connecting portion. The insulating member further includes U-phase insulating attachment portions (330U) attached across the U-phase wire-wound portions, V-phase insulating attachment portions (330V) attached across the V-phase wire-wound portions, and W-phase insulating attachment portions (330W) attached across the W-phase wire-wound portions. The U-phase insulating attachment portions, the V-phase insulating attachment portions, and the W-phase insulating attachment portions respectively have the first insulating portions (332A) and the second insulating portions (332B) as the insulating portions. In each of the U-phase insulating attachment portions, the first insulating portion is arranged between the U-phase wire-wound portion and the V-phase wire-wound portion, and the second insulating portion is arranged between the U-phase wire-wound portion and the W-phase wire-wound portion. In each of the V-phase insulating attachment portions, the first insulating portion is arranged between the V-phase wire-wound portion and the W-phase wire-wound portion, and the second insulating portion is arranged between the V-phase wire-wound portion and the U-phase wire-wound portion. In each of the W-phase insulating attachment portions, the first insulating portion is arranged between the W-phase wire-wound portion and the U-phase wire-wound portion, and the second insulating portion is arranged between the W-phase wire-wound portion and the V-phase wire-wound portion.

### Fourteenth Aspect

The stator as set forth in the above-described first aspect, wherein the wire-wound portions include a plurality of U-phase wire-wound portions, a plurality of V-phase wire-wound portions, and a plurality of W-phase wire-wound portions. The insulating portions (432) are respectively arranged between the U-phase wire-wound portion and the V-phase wire-wound portion, between the U-phase wire-wound portion and the W-phase wire-wound portion, and between the V-phase wire-wound portion and the W-phase wire-wound portion. The connecting member of the insulating member (430) includes a first connecting portion (434A) and a second connecting portion (434B). The first connecting portion is arranged on a first side of the wire-wound portions in an axial direction of the stator core and connects first ends of an adjacent two of the insulating portions to each other. The second connecting portion is arranged on a second side of the wire-wound portions opposite the first side in the axial direction of the stator core and connects second ends of an adjacent two of the insulating portions.

### Fifteenth Aspect

The stator as set forth in any one of the above-described first to fourteenth aspects, wherein the connecting portion is arranged on the first side of the wire-wound portions in an axial direction of the stator core, and has formed therein a through-hole (36, 136, 236, 336, 436) opening in the axial direction of the stator core.

What is claimed is:

1. A stator comprising:
a stator core that includes a plurality of teeth extending in a radial direction of the stator core and a plurality of slots formed between the teeth;
insulators installed in the stator core;
a plurality of wire-wound portions each of which is wound around a respective one of the teeth through a corresponding one of the insulators; and
an insulating member that includes a plurality of insulating portions inserted into selected ones of the slots and a connecting portion, each of the insulating portions electrically insulating an adjacent two of the wire-wound portions from each other, the connecting portion connecting the insulating portions.

2. The stator according to claim 1, wherein the insulating member includes a plurality of insulating members each of which includes, as the insulating portions, a first insulating portion and a second insulating portion,
each of the first insulating portions is inserted into a first selected slot that is one of the selected slots,
each of the second insulating portions is inserted into a second selected slot that is one of the selected slots, and
each of the connecting portions connects first ends of a corresponding one of the first insulating portions and a corresponding one of the second insulating portions to each other, the first ends facing in an axial direction of the stator core.

3. The stator according to claim 2, wherein the second selected slots are arranged adjacent to the first selected slots, respectively.

4. The stator according to claim 2, wherein each of the first insulating portions has a first tip portion located opposite to a corresponding one of the connecting portions,
each of the second insulating portions has a second tip portion located opposite to a corresponding one of the connecting portions,
the connecting portions are arranged on a first side of the wire-wound portions in the axial direction of the stator core,
each of the first tip portions includes a first extending portion that is located on a second side of a corresponding one of the wire-wound portions in the axial direction of the stator core and extends toward a corresponding one of the second insulating portions, and
each of the second tip portions includes a second extending portion that is located on the second side of a corresponding one of the wire-wound portions in the axial direction of the stator core and extends toward a corresponding one of the first insulating portions.

5. The stator according to claim 1, wherein the insulating member includes a plurality of insulating members each of which is formed of a tube having heat shrinkability,
each of the insulating members includes, as the insulating portions, a first insulating portion and a second insulating portion and also includes, as the connecting portions, a first connecting portion and a second connecting portion,
each of the first insulating portions is inserted into a first selected slot that is one of the selected slots,
each of the second insulating portions is inserted into a second selected slot that is one of the selected slots,
each of the first connecting portions connects first ends of a corresponding one of the first insulating portions and a corresponding one of the second insulating portions, and
each of the second connecting portions connects second ends of a corresponding one of the first insulating portions and a corresponding one of the second insulating portions.

6. The stator according to claim 1, wherein the insulating member includes a plurality of insulating members,
the plurality of wire-wound portions include a plurality of U-phase wire-wound portions, a plurality of V-phase wire-wound portions, and a plurality of W-phase wire-wound portions,
the plurality of the insulating members include U-phase insulating members attached across the U-phase wire-wound portions, V-phase insulating members attached across the V-phase wire-wound portions, and W-phase insulating members attached across the W-phase wire-wound portions,
each of the U-phase insulating members, each of the V-phase insulating members, and each of the W-phase insulating members has a first insulating portion and a second insulating portion as the plurality of insulating portions,
in each of the U-phase insulating members, the first insulating portion is arranged between a corresponding one of the U-phase wire-wound portions and a corresponding one of the V-phase wire-wound portions, and the second insulating portion is arranged between a corresponding one of the U-phase wire-wound portions and a corresponding one of the W-phase wire-wound portions,
in each of the V-phase insulating members, the first insulating portion is arranged between a corresponding one of the V-phase wire-wound portions and a corresponding one of the W-phase wire-wound portions, and the second insulating portion is arranged between a corresponding one of the V-phase wire-wound portions and a corresponding one of the U-phase wire-wound portions, and
in each of the W-phase insulating members, the first insulating portion is arranged between a corresponding one of the W-phase wire-wound portions and a corresponding one of the U-phase wire-wound portions, and the second insulating portion is arranged between a corresponding one of the W-phase wire-wound portions and a corresponding one of the V-phase wire-wound portions.

7. The stator according to claim 1, wherein the connecting portion is formed in a ring shape along a circumferential direction of the stator core.

8. The stator according to claim 1, wherein the insulating member is formed of a sheet material, and each of the insulating portions is of a V-shape when viewed from an axial direction of the stator core.

9. The stator according to claim 1, wherein the connecting portion is formed in a cylindrical shape along a circumferential direction of the stator core and is arranged on a radially inner side of the stator core, and each of the insulating portions extends from the connecting portion toward a radially outer side of the stator core.

10. The stator according to claim 1, wherein the wire-wound portions include a plurality of U-phase wire-wound portions, a plurality of V-phase wire-wound portions, and a plurality of W-phase wire-wound portions,
the insulating portions are respectively arranged between the U-phase wire-wound portion and the V-phase wire-wound portion, between the U-phase wire-wound portion and the W-phase wire-wound portion, and between the V-phase wire-wound portion and the W-phase wire-wound portion, and
the connecting portion is formed in a ring shape along a circumferential direction of the stator core.

11. The stator according to claim 1, wherein the insulating member includes first insulating portions and second insulating portions, as the plurality of insulating portions, and the connecting portion includes first connecting portions and second connecting portions, the first insulating portions, the first connecting portions, the second insulating portions, and the second connecting portions being repeatedly and continuously arranged in order of the first insulating portion, the first connecting portion, the second insulating portion, and the second connecting portion,
the first insulating portions are inserted into first selected slots that are selected ones of the slots, the second insulating portions are inserted into second selected slots each of which is adjacent to one of the first selected slots,
the first connecting portions are arranged on a first side of the wire-wound portions in an axial direction of the stator core, and
the second connecting portions are arranged on a second side of the wire-wound portions in the axial direction of the stator core.

12. The stator according to claim 1, wherein the wire-wound portions include a plurality of U-phase wire-wound portions, a plurality of V-phase wire-wound portions, and a plurality of W-phase wire-wound portions,
the insulating member includes first insulating portions and second insulating portions as the insulating portions, the connecting portion including first connecting portions and second connecting portions, the first insulating portions, the first connecting portions, the second insulating portions, and the second connecting portions being repeatedly and continuously arranged in order of the first insulating portion, the first connecting portion, the second insulating portion, and the second connecting portion,
the insulating member further includes U-phase insulating attachment portions attached across the U-phase wire-wound portions, V-phase insulating attachment portions attached across the V-phase wire-wound portions, and W-phase insulating attachment portions attached across the W-phase wire-wound portions,
the U-phase insulating attachment portions, the V-phase insulating attachment portions, and the W-phase insulating attachment portions respectively have the first insulating portions and the second insulating portions as the insulating portions,
in each of the U-phase insulating attachment portions, the first insulating portion is arranged between the U-phase wire-wound portion and the V-phase wire-wound portion, and the second insulating portion is arranged between the U-phase wire-wound portion and the W-phase wire-wound portion,
in each of the V-phase insulating attachment portions, the first insulating portion is arranged between the V-phase wire-wound portion and the W-phase wire-wound portion, and the second insulating portion is arranged between the V-phase wire-wound portion and the U-phase wire-wound portion, and
in each of the W-phase insulating attachment portions, the first insulating portion is arranged between the W-phase wire-wound portion and the U-phase wire-wound portion, and the second insulating portion is arranged between the W-phase wire-wound portion and the V-phase wire-wound portion.

13. The stator according to claim 1, wherein the wire-wound portions include a plurality of U-phase wire-wound portions, a plurality of V-phase wire-wound portions, and a plurality of W-phase wire-wound portions,
the insulating portions are respectively arranged between the U-phase wire-wound portion and the V-phase wire-wound portion, between the U-phase wire-wound portion and the W-phase wire-wound portion, and between the V-phase wire-wound portion and the W-phase wire-wound portion,
the connecting member of the insulating member includes a first connecting portion and a second connecting portion,
the first connecting portion is arranged on a first side of the wire-wound portions in an axial direction of the stator core and connects first ends of an adjacent two of the insulating portions to each other, and
the second connecting portion is arranged on a second side of the wire-wound portions opposite the first side in the axial direction of the stator core and connects second ends of an adjacent two of the insulating portions.

14. The stator according to claim 1, wherein the connecting portion is arranged on the first side of the wire-wound portions in an axial direction of the stator core, and has formed therein a through-hole opening in the axial direction of the stator core.
